(19) United States
(12) Patent Application Publication
(10) Pub. No.: US 2024/0160120 A1
(43) Pub. Date: May 16, 2024

(54) ELECTROPHOTOGRAPHIC PHOTORECEPTOR, METHOD FOR MANUFACTURING THE SAME, AND ELECTROPHOTOGRAPHIC IMAGE FORMING APPARATUS USING THE SAME

(71) Applicant: Konica Minolta, Inc., Tokyo (JP)

(72) Inventors: Takeshi ISHIDA, Tokyo (JP); Akihiko ITAMI, Tokyo (JP); Toshiyuki FUJITA, Tokyo (JP); Kazukuni NISHIMURA, Tokyo (JP)

(21) Appl. No.: 18/475,625

(22) Filed: Sep. 27, 2023

(30) Foreign Application Priority Data
Oct. 21, 2022 (JP) 2022-168732

(51) Int. Cl. G03G 5/147; G03G 5/047; G03G 5/06; G03G 21/16

(52) U.S. Cl. CPC G03G 5/14786; G03G 5/047; G03G 5/0696; G03G 5/14704; G03G 21/1661

(57) ABSTRACT

An electrophotographic photoreceptor includes a photosensitive layer on a support, wherein the photosensitive layer includes at least a charge generating layer, a charge transporting layer, and a protective layer, the charge generating layer contains titanyl phthalocyanine or a derivative thereof, the charge transporting layer contains a charge transporting material, the protective layer contains a reactant of a polymerizable monomer having a charge transporting structure and a polymerizable monomer having no charge transporting structure, and the charge transporting material, and a ratio of the mass of the charge transporting material contained in the protective layer is greater than 3% by mass and less than 9% by mass with respect to the total mass of a reactant of the polymerizable monomer having the charge transporting structure and the polymerizable monomer having no charge transporting structure, and the charge transporting material.

### CROSS-REFERENCE TO RELATED APPLICATIONS

The entire disclosure of Japanese Patent Application No. 2022-168732 filed on Oct. 21, 2022 is incorporated herein by reference in its entirety.

### BACKGROUND

### Technical Field

The present invention relates to an electrophotographic photoreceptor, a method for manufacturing the same, and an electrophotographic image forming apparatus using the same. More specifically, the present invention relates to an electrophotographic photoreceptor that achieves both wear resistance and high image quality in long-term use, a method for manufacturing the same, and an electrophotographic image forming apparatus using the same.

### Description of the Rerated Art

In recent years, a long-life photoreceptor has been demanded from the viewpoint of environmental friendliness and cost. It has been demanded to continuously provide high-quality images over a long period of time by using an image forming apparatus or the like provided with the same.

In order to extend the life of the photoreceptor and to provide high-quality images, for example, it is necessary to reduce the amount of the photoreceptor wear and suppress the increase in residual potential.

In order to achieve both, methods for forming a protective layer in which a crosslinked film having a charge transporting structure is formed on a charge transporting layer of a photoreceptor are disclosed (see JP 2009-31790A and JP 2018-205671A).

In the above-described methods, the amount of photoreceptor wear is reduced and the increase in residual potential is suppressed by controlling the amount of diffusion/transfer of the charge transporting material from the charge transporting layer to the protective layer.

Thus, image defects such as image memory generation are prevented.

In recent image formation, it has become important to obtain a desired toner charge amount by friction in a very short time, and the charge rising property of how fast and uniformly charged is emphasized.

However, in the above-described methods, there are some problems that the image-quality deteriorates due to a decrease in the charge rising property of the photoreceptor, the occurrence of cracks, and the like.

As described above, there is room for improvement in order to improve wear resistance and improve image quality in long-term use.

### SUMMARY

The present invention has been made in view of the above-described problems and circumstances, and a problem to be solved is to provide an electrophotographic photoreceptor that achieves both wear resistance and high image quality in long-term use, a method for manufacturing the same, and an electrophotographic image forming apparatus using the same.

In order to solve the above problems, the present inventors have found that, as the result of reviewing the causes and the like of the above problems, it can be solved by using an electrophotographic photoreceptor in which the charge generating layer contains titanyl phthalocyanine or a derivative thereof, the charge transporting layer contains a charge transporting material, and a ratio of the mass of the charge transporting material in the protective layer is within a certain range, and reached the present invention.

That is, the above-described problem according to the present invention is solved by the following means.

To achieve at least one of the abovementioned objects, according to an aspect of the present invention, the electrophotographic photoreceptor reflecting one aspect of the present invention is an electrophotographic photoreceptor comprising a photosensitive layer on a support, wherein
the photosensitive layer includes at least a charge generating layer, a charge transporting layer, and a protective layer,
the charge generating layer contains titanyl phthalocyanine or a derivative thereof,
the charge transporting layer contains a charge transporting material,
the protective layer contains a reactant of a polymerizable monomer having a charge transporting structure and a polymerizable monomer having no charge transporting structure, and the charge transporting material, and
a ratio of the mass of the charge transporting material contained in the protective layer is greater than 3% by mass and less than 9% by mass with respect to the total mass of the reactant of the polymerizable monomer having the charge transporting structure and the polymerizable monomer having no charge transporting structure, and the charge transporting material.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a cross-sectional view showing an exemplary layer of an electrophotographic photoreceptor of the present invention;

FIG. 2 is an explanatory cross-sectional view showing an exemplary configuration of an image forming apparatus;

FIG. 3 is an explanatory cross-sectional view showing an exemplary configuration of a main part of an image forming apparatus;

FIG. 4 is a schematic diagram showing an exemplary configuration of a charger;

FIG. 5 is a schematic diagram showing an example of a measurement point when measuring a difference in density level;

FIG. 6 is a conceptual diagram of an example showing the value of Vpp of an AC voltage; and

FIG. 7 is a conceptual diagram of an example showing Vknee.

### DETAILED DESCRIPTION

Hereinafter, one or more embodiments of the present invention will be described with reference to the drawings. However, the scope of the invention is not limited to the disclosed embodiments.

The electrophotographic photoreceptor of the present invention is an electrophotographic photoreceptor having a photosensitive layer on a support, characterized in that:
the photosensitive layer includes at least a charge generating layer, a charge transporting layer, and a protective layer,
the charge generating layer contains titanyl phthalocyanine or a derivative thereof,
the charge transporting layer contains a charge transporting material,
the protective layer contains a reactant of a polymerizable monomer having a charge transporting structure and a polymerizable monomer having no charge transporting structure, and the charge transporting material, and
a ratio of the mass of the charge transporting material contained in the protective layer is greater than 3% by mass and less than 9% by mass with respect to the total mass of a reactant of the polymerizable monomer having the charge transporting structure and the polymerizable monomer having no charge transporting structure, and the charge transporting material.

This feature is a technical feature common to or corresponding to each of the following embodiments (aspects).

In an embodiment of the present invention, it is preferable that a total thickness of the charge transporting layer and the protective layer is in the range of 13 to 25 μm from the viewpoint of suppressing a decrease in wear resistance and nonuniform wear. It is also preferable from the viewpoint of preventing cracks and film peeling.

It is preferable that the absolute value of a difference in ionization potential between the polymerizable monomer having the charge transporting structure and the charge transporting material is equal to or less than 0.35 eV from the viewpoint of degradation resistance of the surface layer and hole injecting and transporting properties.

It is preferable that the protective layer contains metal oxide particles from the viewpoint of improving wear resistance of the protective layer.

It is preferable that the metal oxide particles are SiO₂ particles from the viewpoint that the surface hardness of the photoreceptor is increased and the wear resistance is further improved by dispersing SiO₂ particles having higher hardness.

It is preferable that the metal oxide particles are surface-modified with a surface modifying agent having a radically polymerizable group from the viewpoint of forming a dense three-dimensional network structure and improving the crosslinking density.

It is more preferable that the metal oxide particles are surface-modified with a surface modifying agent having an acrylic group or a methacrylic group from the viewpoint of forming a dense three-dimensional network structure and improving the crosslinking density.

It is more preferable that a ratio of the mass of the charge transporting material contained in the protective layer is greater than 3% by mass and less than 5% by mass with respect to the total mass of a reactant of the polymerizable monomer having the charge transporting structure and the polymerizable monomer having no charge transporting structure, and the charge transporting material, from the viewpoint of suppressing cracks and suppressing image noise due to the difference in density level.

It is preferable that the photosensitive layer contains a solvent having a solubility parameter of 10[(cal/cm³)^{1/2}] or more and a molecular structure of 4 or more carbon atoms from the viewpoint of controlling the transfer amount of the charge transporting material from the charge transporting layer to the protective layer.

A method of manufacturing an electrophotographic photoreceptor of the present invention for manufacturing an electrophotographic photoreceptor of the present invention includes at least a step of forming the charge transporting layer and the protective layer using a coating liquid, wherein the coating liquid for forming a protective layer contains a solvent having a solubility parameter of 10[(cal/cm³)^{1/2}] or more and having a molecular structure of 4 or more carbon atoms.

As a result, the effects of the present invention are exhibited, and the problem can be solved.

An electrophotographic image forming apparatus comprising a charger, an exposure device, a developing device, and a transfer device of the present invention is characterized by comprising an electrophotographic photoreceptor of the present invention.

As a result, the effects of the present invention are exhibited, and the problem can be solved.

It is preferable that the charger is a proximity charging roller and a contact charging roller from the viewpoint that harmful ozone gas due to the charging process is less generated and it is advantageous for improving image quality and downsizing the apparatus.

It is preferable that the developer supplied by the developing device contains a lubricant from the viewpoint of improving wear resistance.

It is more preferable that the lubricant is a metal soap from the viewpoint of improving wear resistance.

Hereinafter, the present invention, its constituent elements, and embodiments and aspects for carrying out the present invention will be described in detail. In the present application, “to” is used in the meaning that numerical values described before and after are included as a lower limit value and an upper limit value.

### [I. Electrophotographic Photoreceptor]

An electrophotographic photoreceptor of the present invention comprises a photosensitive layer on a support, characterized in that:
the photosensitive layer includes at least a charge generating layer, a charge transporting layer, and a protective layer,
the charge generating layer contains titanyl phthalocyanine or a derivative thereof,
the charge transporting layer includes a charge transporting material,
the protective layer contains a reactant of a polymerizable monomer having a charge transporting structure and a polymerizable monomer having no charge transporting structure, and the charge transporting material,
a ratio of the mass of the charge transporting material contained in the protective layer is more than 3% by mass and less than 9% by mass with respect to the total mass of a reactant of the polymerizable monomer having the charge transporting structure and the polymerizable monomer having no charge transporting structure, and the charge transporting material.

The photoreceptor of the present invention may further include other layers than the respective layers described above. Other layers include, for example, an intermediate layer laminated on a conductive support.

The intermediate layer has, for example, a barrier function or an adhesive function.

In the present specification, the “photosensitive layer” refers to a layer including at least a charge generating layer, a charge transporting layer, and a protective layer, other than the conductive support, in the following examples of the layer configuration, and may further include an intermediate layer as a layer constituting the photosensitive layer.

Specific examples of the layer configuration of the photoreceptor of the present invention are shown below.
(1) Conductive support/charge generating layer/charge transporting layer/protective layer
(2) Conductive support/charge transporting layer which also serves as a charge generating layer/protective layer
(3) Conductive support/intermediate layer/charge generating layer/charge transporting layer/protective layer
(4) Conductive support/intermediate layer/charge transporting layer which also serves as a charge generating layer/protective layer

The layer configuration of the electrophotographic photoreceptor of the present invention may be any of the layer configurations (1) to (4) described above, and among these, the layer configuration (3) is particularly preferable.

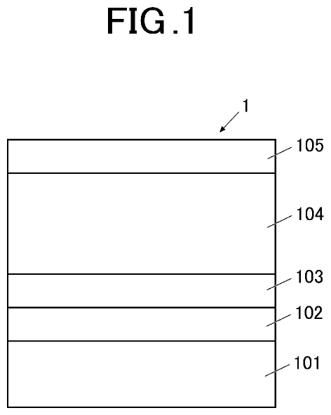

FIG. 1 is a cross-sectional view showing an exemplary layer of an electrophotographic photoreceptor of the present invention.

In the electrophotographic photoreceptor 1 shown in FIG. 1, an intermediate layer 102, a charge generating layer 103, a charge transporting layer 104, and a protective layer 105 are sequentially stacked on a conductive support 101.

The electrophotographic photoreceptor of the present invention is an organic photoreceptor.

The “organic photoreceptor” means an electrophotographic photoreceptor in which at least one of a charge generating function and a charge transporting function essential for an electrophotographic photoreceptor is expressed by an organic compound.

In addition, the above meaning includes a photoreceptor composed of a known organic charge generating material or an organic charge transporting material, and a photoreceptor composed of a polymer complex composed of a charge generating function and a charge transporting function.

### 1. Protective Layer

### (1.1) Polymerizable Monomer

The protective layer according to the present invention contains a reactant of a polymerizable monomer having a charge transporting structure and a polymerizable monomer having no charge transporting structure.

The “polymerizable monomer” refers to a compound having a polymerizable group and polymerizing (curing) by irradiation with an active energy ray such as ultraviolet rays, visible rays, or electron beams, or by addition of energy such as heating.

The protective layer is characterized in that it contains the charge transporting material, and a ratio of the mass is more than 3% by mass and less than 9% by mass with respect to the total mass of the reactant and the charge transporting material.

### (1.1.1) Polymerizable Monomer Having Charge Transporting Structure

The “polymerizable monomer having a charge transporting structure” according to the present invention refers to a polymerizable monomer exhibiting charge transport properties due to the structure of the polymerizable monomer itself.

Examples of the polymerizable monomer having a charge transporting structure include triphenylamine derivatives, carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl derivatives, hydrazone derivatives, pyrazoline derivatives, oxazolone derivatives, benzimidazole derivatives, quinazoline derivatives, benzofuran derivatives, acridine derivatives, phenazine derivatives, aminostilbene derivatives, phenylenediamine derivatives, stilbene derivatives and benzidine derivatives.

Among the above examples, triphenylamine derivatives are preferable, and one of the phenyl groups included in the triphenylamine derivatives is preferably a biphenyl group.

The polymerizable monomer having a charge transporting structure according to the present invention preferably has a chain polymerizable functional group.

The “chain polymerizable functional group” refers to a functional group capable of a reaction by chain polymerization.

The chain polymerization mainly includes addition polymerization and ring-opening polymerization.

The “addition polymerization” is a reaction in which a functional group having an unsaturated moiety such as C═C, C═O, C═N, and C═N is chain-polymerized by a radical, an ion, or the like.

The main reaction is a chain polymerization of a functional group having C═C.

Specific examples of the addition-polymerizable functional group are shown below.

In the following structures, * represents a binding site. R represents a hydrogen atom or a substituent such as an alkyl group, an aralkyl group, or an aryl group.

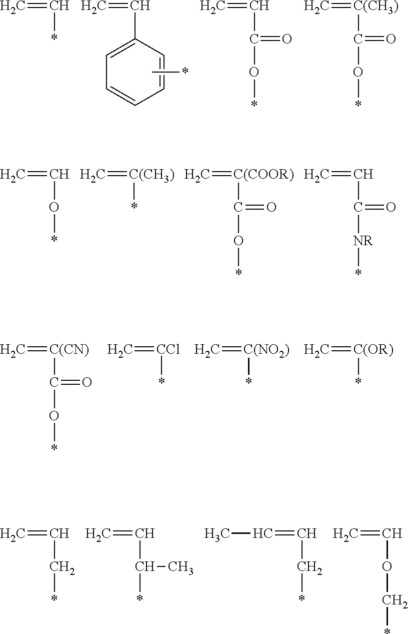

The “ring-opening polymerization” refers to a reaction in which a ring structure having a large steric strain is opened and chain polymerization is performed.

Specific examples of the ring-opening polymerizable functional group are shown below.

In the structural formulae, * represents a binding site.

R represents a hydrogen atom or a substituent such as an alkyl group, an aralkyl group, or an aryl group.

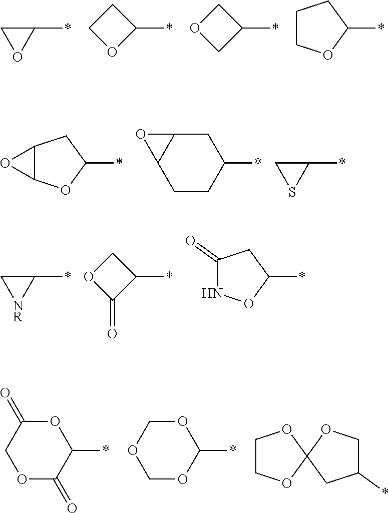

Among the chain polymerizable functional groups described above, an addition polymerizable functional group is preferable, and an acryloyloxy group (CH₂═CHCOO—) or a methacryloyloxy group (CH₂═C(CH₃)COO—) is more preferable.

The polymerizable monomer having a charge transporting structure according to the present invention is not limited to a specific compound, and may have other substituents or linking groups as long as the polymerizable monomer exhibits charge transporting property.

The polymerizable monomer having a charge transporting structure preferably has a structure represented by the following formula (1).

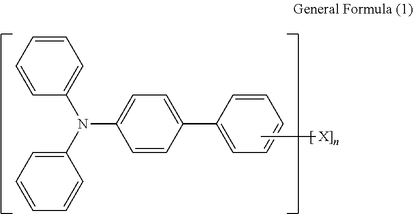

[In the general formula (1), the substituent X of the aryl group represents an acryloyloxy group or a methacryloyloxy group which may have an alkylene group, an oxyalkylene group, or a polyoxyalkylene group between the X and the aryl group. n represents an integer of 1 to 3. The hydrogen atom of the aryl group may be substituted with any of an alkyl group having 1 to 10 carbon atoms, an alkoxy group having 1 to 10 carbon atoms, and a halogeno group in addition to the substituent X.]

The substituent X represents an acryloyloxy group or a methacryloyloxy group which is a chain polymerizable functional group, and may have an alkylene group, an oxyalkylene group, or a polyoxyalkylene group between the X and the aryl group.

The substituent X may have an alkylene group, which is a linking group having a structure represented by —(CH₂)ₙ—. When the substituent X has an alkylene group, n in —(CH₂)ₙ— is preferably an integer of 1 to 6, and more preferably an integer of 1 to 3.

The substituent X may have an oxyalkylene group or a polyoxyalkylene group, which is a linking group having a structure represented by —(OCH₂CH₂)ₙ—. When n in —(OCH₂CH₂)ₙ— is 1, it is referred to as an oxyalkylene group, and when n is 2 or more, it is referred to as a polyoxyalkylene group. When the substituent X has an oxyalkylene group or a polyoxyalkylene group, n in —(OCH₂CH₂)ₙ— is preferably an integer of 1 to 6, more preferably an integer of 1 to 3.

Examples of the alkyl group having 1 to 10 carbon atoms that can be substituted for hydrogen atoms possessed by an aryl group include a methyl group, an ethyl group, a n-propyl group, a n-butyl group, a n-pentyl group, a n-hexyl group, a n-heptyl group, a n-octyl group, a n-nonyl group, a n-decyl group, an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, an sec-octyl group, a tert-octyl group, an isononyl group, a sec-nonyl group, a tert-nonyl group, an isodecyl group, a sec-decyl group, and a tert-decyl groups. Among these, a lower alkyl group such as a methyl group, an ethyl group, and an isopropyl group, is preferable.

Examples of the alkoxy group having 1 to 10 carbon atoms that can be substituted for hydrogen atoms possessed by an aryl group include a methoxy group, an ethoxy group, a n-propoxy group, a n-butoxy group, a n-pentyloxy group, a n-hexyloxy group, a n-heptyloxy group, a n-octyloxy group, a n-nonyloxy group, a n-decyloxy group, an isopropoxy group, an isobutoxy group, an sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Among these, a methoxy group or an ethoxy group is preferable.

Examples of the halogen group that can be substituted for hydrogen atoms possessed by an aryl group include a fluoro group, a chloro group, a bromo group, an iodo group, and the like.

The polymerizable monomer having a charge transporting structure preferably has a structure represented by the above general formula (1) for the following reasons.

In order to improve the charge transporting property, a compound having a relatively large skeleton of a π-conjugated system is generally used as a polymerizable monomer exhibiting the charge transporting property of a common electrophotographic photoreceptor.

However, since the polymerizable monomer exhibiting the charge transporting property of a common electrophotographic photoreceptor strongly absorb the light within the wavelength range of 360 to 400 nm suitably used in the photocuring reaction, it is difficult to apply the photocuring reaction to form a layer including the compound.

In contrast, the monomer having a structure represented by the general formula (1) does not absorb the light within the wavelength range of 360 to 400 nm and has a charge transporting function equivalent to that of the polymerizable monomer exhibiting the charge transporting property of a common electrophotographic photoreceptor.

Therefore, by using the monomer having a structure represented by the general formula (1), a protective layer having sufficient charge transporting function can be formed by applying a photocuring reaction which is a simple method.

The structure of the polymerizable monomer having a charge transporting structure according to the present invention is exemplified below.

Of these, T-1 to T-13 corresponds to the structure represented by the general formula (1).

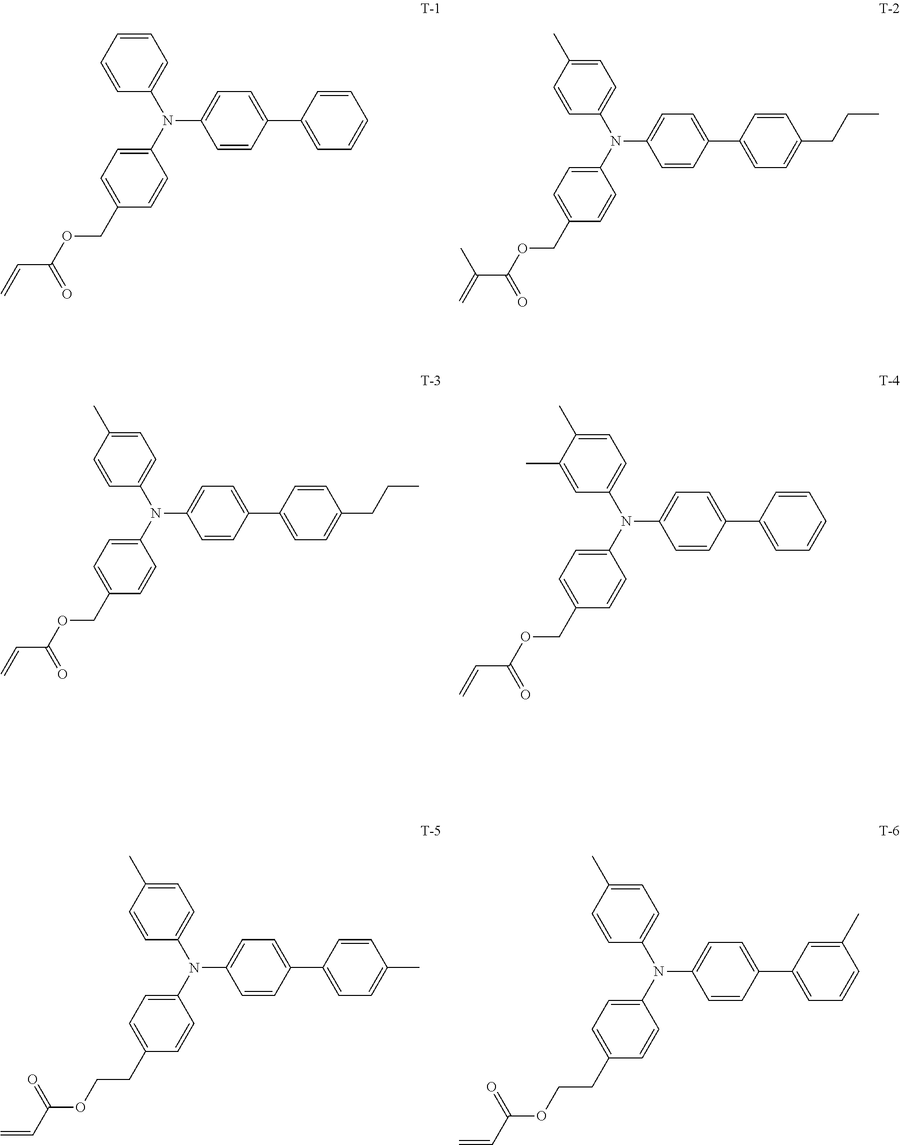

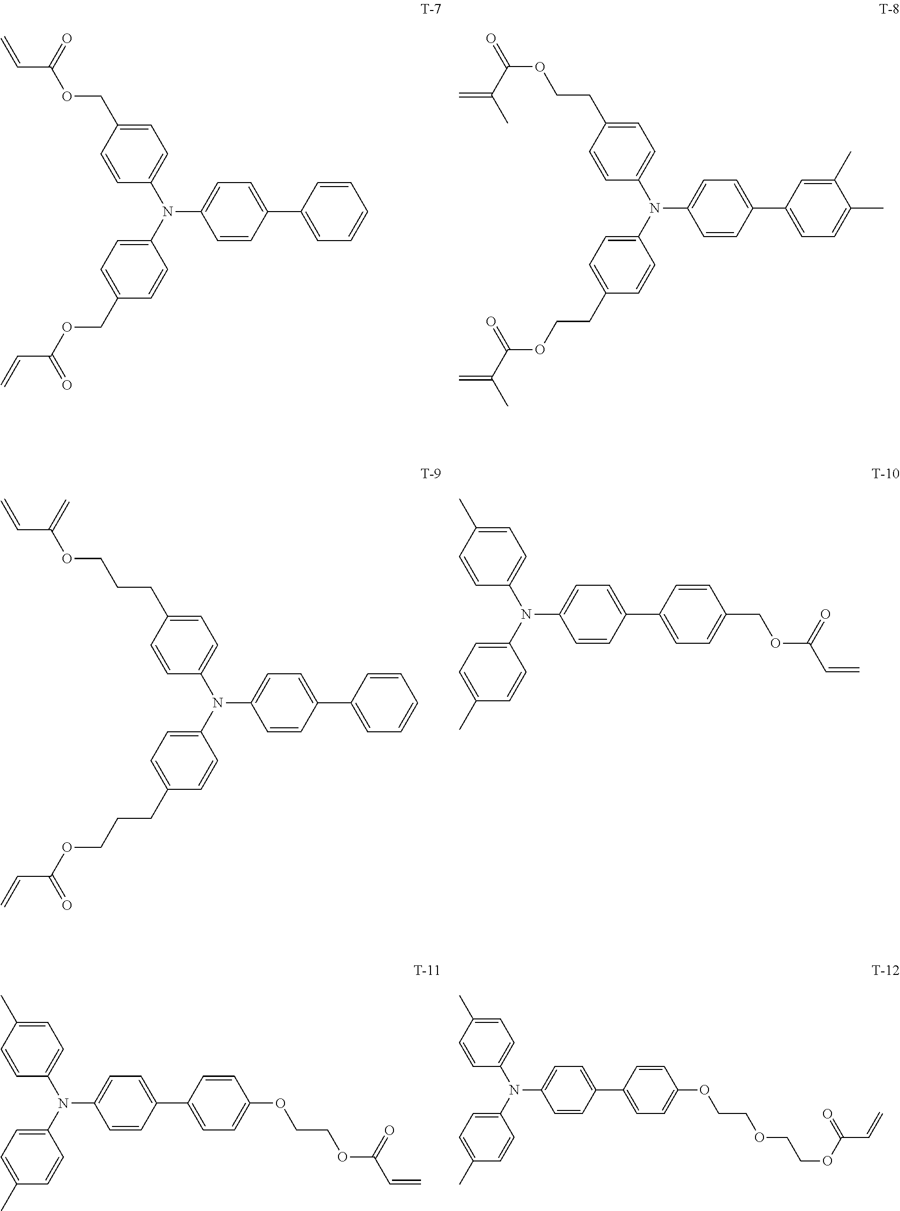

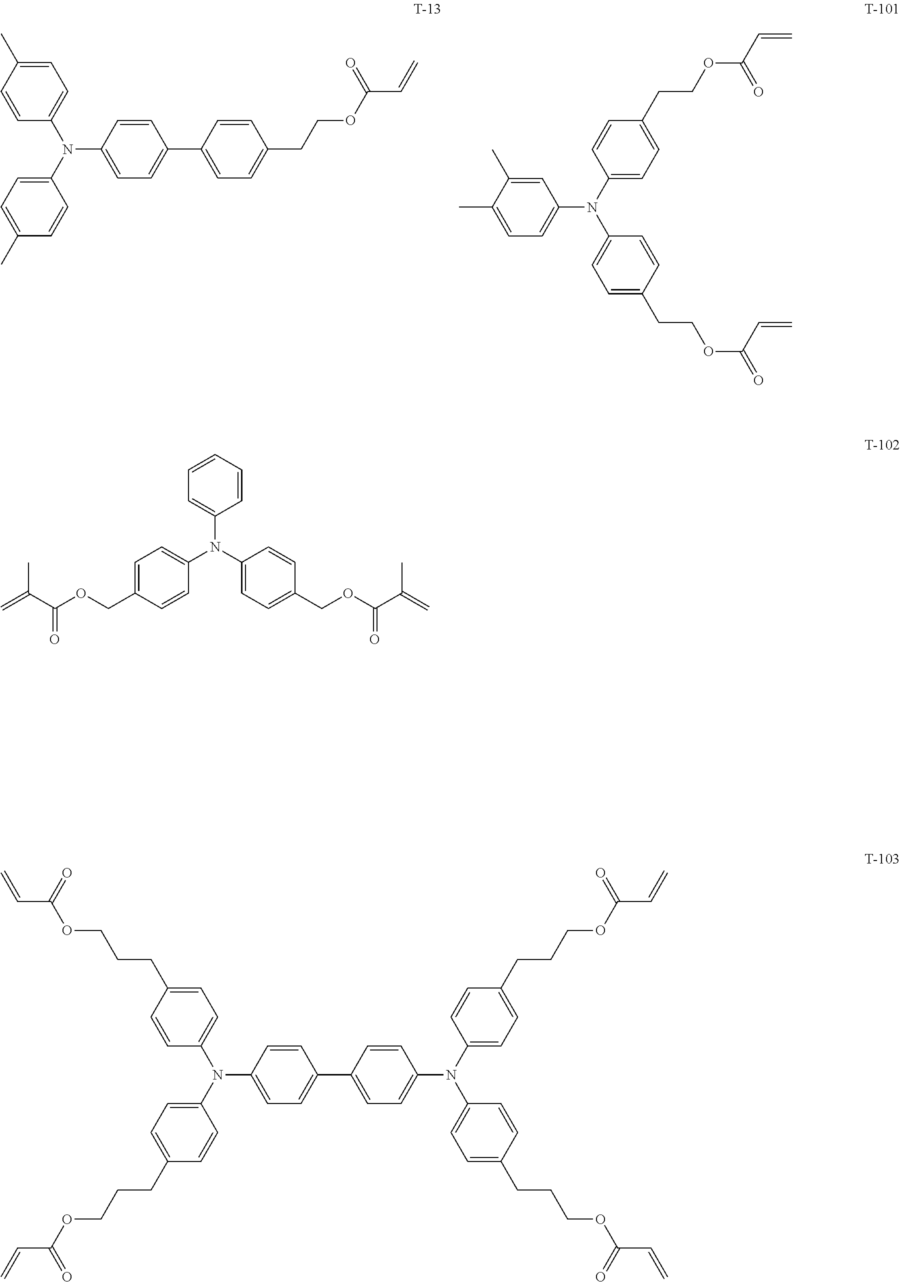

The polymerizable monomer having a charge transporting structure can be synthesized by a known method.

For example, a compound having a structure T-3 can be synthesized by an esterification reaction between an N,N-diphenyl-N-biphenylamine derivative having a hydroxyl group and an acrylic acid chloride as shown in the following reaction formula.

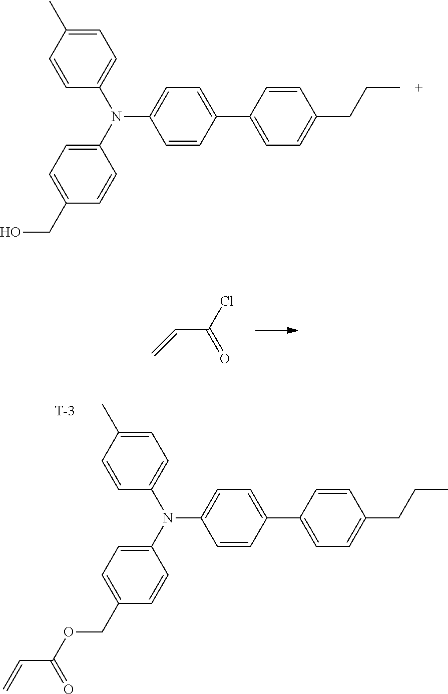

The content ratio of the polymerizable monomer having a charge transporting structure in the protective layer forming composition is preferably in the range of 10 to 90% by mass, and more preferably in the range of 20 to 80% by mass, with respect to the total amount of the protective layer forming composition.

When the content ratio is 10% by mass or more, a sufficient charge transporting property can be obtained, whereby sufficient memory resistance can be obtained.

Further, when the content ratio is 90% by mass or less, a sufficient crosslinking density of the protective layer is obtained, whereby sufficient wear resistance is obtained.

In the present invention, the “protective layer forming composition” is a component of a polymerizable monomer having a charge transporting structure, a polymerizable monomer having no charge transporting structure, a polymerization initiator, or the like.

However, in the present specification, a solvent is not included in the “protective layer forming composition”.

The above “protective layer forming composition” may contain other components as long as the effects of the present invention are not impaired.

Examples of other components include inorganic fine particles, lubricious organic fine particles, antioxidants, stabilizers, and silicone oils.

It is possible to confirm that the protective layer contains a cured product of a composition containing a polymerizable monomer having a charge transporting structure by analyzing an alkaline hydrolysate obtained by alkaline hydrolysis of the protective layer with a known instrument analysis such as NMR, IR, mass-spectrometry, or the like.

### (1.1.2) Polymerizable Monomer Having no Charge Transporting Structure

The protective layer according to the present invention contains a reactant of a polymerizable monomer having a charge transporting structure and a polymerizable monomer having no charge transporting structure.

The polymerizable monomer having no charge transporting structure exhibits no charge transporting property unlike the polymerizable monomer having the charge transporting structure described above.

The above polymerizable monomer having no charge transporting structure is preferably a polymerizable monomer having three or more functional groups.

The polymerizable monomer having three or more functional groups may be a compound in which a three- dimensional network structure is introduced into the matrix of the protective layer by polymerization only between molecules of the polymerizable monomer having three or more functional groups.

Further, the polymerizable monomer having three or more functional groups may be a monomer which polymerizes integrally with the polymerizable monomer having the charge transporting structure described above and introduces a three-dimensional network structure into the matrix of the protective layer.

As a result, the crosslinking density of the matrix of the protective layer is increased, a protective layer having high hardness and high elasticity is obtained, and higher wear resistance and scratch resistance can be achieved.

The polymerizable group of the polymerizable monomer having three or more functional groups is preferably an addition-polymerizable functional group.

Among the addition-polymerizable functional groups, an acryloyloxy group (CH₂═CHCOO—) or a methacryloyloxy group (CH₂═C(CH₃)COO—) is particularly preferable because it can be cured with a small amount of light or in a short period of time.

When using a polymerizable monomer having three or more functional groups as a polymerizable monomer having no charge transporting structure according to the present invention, typically the part other than the polymerizable group is preferred as follows.

It is aliphatic hydrocarbon groups which may have an oxygen atom between carbon atoms and isocyanuric rings, or the like.

The content ratio of the polymerizable monomer having three or more functional groups is preferably in the range of 20 to 80% by mass and more preferably in the range of 30 to 70% by mass with respect to the total amount of the protective layer forming composition.

When the content ratio of the polymerizable monomer having three or more functional groups is 20% by mass or more, the matrix of the obtained protective layer has a structure having a sufficient crosslinking density, and the wear resistance of the protective layer is sufficiently improved.

When the content ratio of the polymerizable monomer having three or more functional groups is 80% by mass or less, the content of the polymerizable monomer having a charge transporting structure is not reduced, the charge transporting ability of the protective layer is sufficient, and the memory resistance is excellent.

Specifically, examples of the polymerizable monomer having three or more functional groups include the compounds (compound M1 to compound M11) which show the structures in following M1 to M11.

However, the present invention is not limited thereto.

In the formulae below, R represents an acryloyl group (CH₂═CHCO—), and R′ represents a methacryloyl group (CH₂═C(CH₃)CO—).

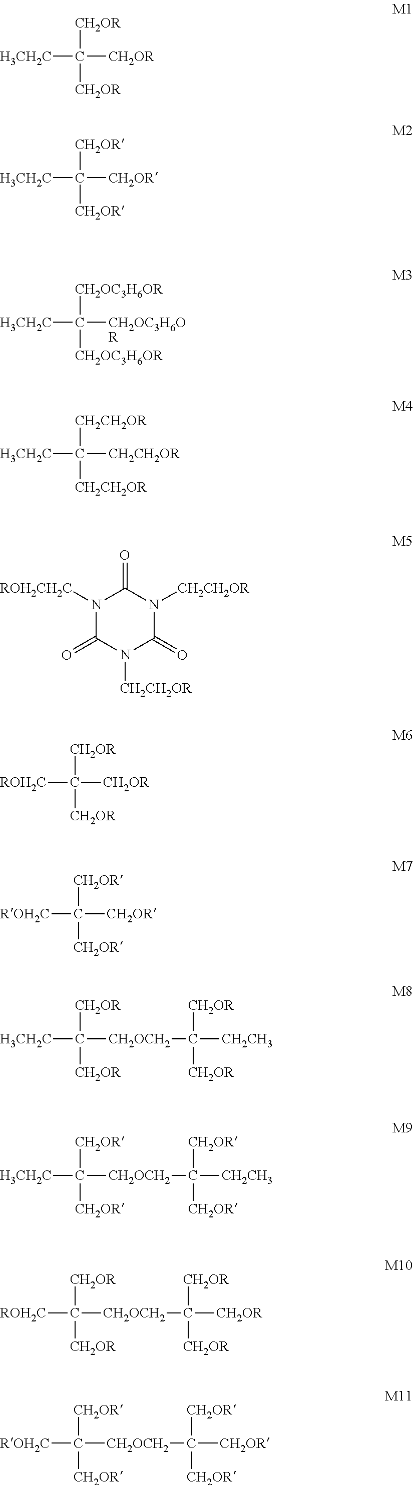

The polymerizable monomer having three or more functional groups may be a synthetic product or a commercial product.

Further, the polymerizable monomer having three or more functional groups may be used alone or in combination of two or more.

### (1.1.3) Ionization Potential

It is preferable that an absolute value of a difference in ionization potential between the polymerizable monomer having the charge transporting structure and the charge transporting material is equal to or less than 0.35 eV value from the viewpoint of degradation resistance of the surface layer and hole injecting and transporting properties.

The “ionization potential” (hereinafter also simply referred to as “Ip value”) is also referred to as a work function and is measured by the following measuring method.

Then, it is quantified as an energy (eV) for drawing out electrons from the measured material, and it can be used to evaluate the charging property caused by contact between various materials.

The protective layer contains a reactant of a polymerizable monomer having a charge transporting structure and a polymerizable monomer having no charge transporting structure, and the charge transporting layer contains a charge transporting material.

Therefore, it is considered that the larger the ionization potential of the polymerizable monomer having the charge transporting structure is compared with the charge transporting material, the higher the charge transporting property is.

Therefore, it is more preferable from the viewpoint of charge transporting property that the absolute value of a difference in ionization potential between the polymerizable monomer having the charge transporting structure and the charge transporting material is equal to or less than 0.35 eV.

The Ip value is measured using a surface analyzer (e.g., AC-1, low-energy electronic counting system manufactured by Riken Keiki Co., Ltd.).

According to the present invention, in the above-described device, a deuterium lamp is used, the irradiation light amount is set to 200 nW, and monochromatic light is selected by a spectroscope.

In addition, the spot size is set to 4 mm square, and the sample shall be irradiated at the energy scanning range of 4.2 to 6.2 eV and the measurement time of 10 sec/1 point.

Then, photoelectrons emitted from the sample surface are detected and processed using a work function measuring software, and the Ip value is measured with a repetition accuracy (standard deviation) of 0.02 eV.

In order to ensure data reproducibility, a measurement sample shall be prepared by allowing the sample to stand for 24 hours under the conditions of operating temperature and humidity of 25° C. and 55% RH.

The measurement cell is shaped with a recess in the center of the stainless-steel disk with the diameter of 13 mm and height of 5 mm for placing the measurement sample with the diameter of 10 mm and the depth of 1 mm.

The evaluation sample is placed in the recesses of the cell without compacting with a scoopula, and then subjected to measurement with the surface leveled and flattened with a knife edge.

After the measurement cell filled with the evaluation sample is fixed on the specified position of the sample table, the irradiation light amount is set to 200 nW, and the measurement cell is measured under the condition of the energy scanning range of 4.2 to 6.2 eV.

### (1.1.4) Polymerization Initiator

In the present invention, the polymerization initiator is used when polymerizing a polymerizable monomer having a charge transporting structure, a polymerizable monomer having no charge transporting structure, or the like.

The polymerization initiator is appropriately selected according to the type of the polymerizable monomer described above, and may be used alone or in combination of two or more.

In the present invention, the polymerization initiator may be a thermal polymerization initiator or a photopolymerization initiator, but is preferably a photopolymerization initiator, and particularly preferably a radical polymerization initiator.

The radical polymerization initiator is not particularly limited, and a known radical polymerization initiator can be used, and examples thereof include an alkylphenone compound and a phosphine oxide compound.

Among these, a compound having an a-aminoalkylphenone structure or an acylphosphine oxide structure is preferable, and a compound having an acylphosphine oxide structure is more favorable.

Examples of the compound having an acylphosphine oxide structure include “Omnirad819” [bis(2,4,6-trimethylbenzoyl) phenylphosphine oxide, manufactured by IGM Resins B.V.].

The content of the polymerization initiator in the protective layer forming composition is preferably within a range of 0.1 to 20 parts by mass, and more preferably within a range of 0.5 to 10 parts by mass, with respect to 100 parts by mass of the total amount of the polymerizable monomer having a charge transporting structure and the polymerizable monomer having no charge transporting structure.

(1.2) Ratio of mass of Charge Transporting Material

The protective layer according to the present invention contains a reactant of a polymerizable monomer having a charge transporting structure and a polymerizable monomer having no charge transporting structure, and a charge transporting material.

The ratio of the mass of the charge transporting material contained in the protective layer is greater than 3% by mass and less than 9% by mass with respect to the total mass of the reactant of the polymerizable monomer having the charge transporting structure and the polymerizable monomer having no charge transporting structure, and the charge transporting material.

The above charge transporting material diffused and transferred from the charge transporting layer which will be described later to the protective layer during the production of the photoreceptor.

By setting the ratio of a mass of the charge transporting material contained in the protective layer to be greater than 3% by mass with respect to the total mass of the reactant of the polymerizable monomer having the charge transporting structure and the polymerizable monomer having no charge transporting structure and the charge transporting material, the charge rising property in the low-temperature and low-humidity environment after the durability test can be improved, and image noise due to the difference in density level can be prevented.

Further, by setting the ratio to be less than 9% by mass, cracks in the protective layers caused by adhesion of sebum, oil, or the like can be suppressed, and the effect of reducing the amount of photoreceptor wear can be obtained.

The ratio of the mass of the charge transporting material contained in the protective layer is more preferably greater than 3% by mass and less than 5% by mass with respect to the total mass of the reactant of the polymerizable monomer having the charge transporting structure and the polymerizable monomer having no charge transporting structure, from the viewpoint of suppressing cracks and suppressing image noise due to the difference in density level.

### (Calculation Method of Ratio of Mass of Charge Transporting Material)

The ratio of the mass (M_{CT} [%]) of the charge transporting material contained in the protective layer is represented by the following Equation (1).

M_{CT} [%]=(mass of a charge transporting material contained in the protective layer)/(mass of a charge transporting material contained in the protective layer+mass of a reactant of a polymerizable monomer having a charge transporting structure and a polymerizable monomer having no charge transporting structure)×100. Equation (1)

In the present invention, the “mass of a reactant of a polymerizable monomer having a charge transporting structure and a polymerizable monomer having no charge transporting structure” is defined as the total amount of the mass of the polymerizable monomer having a charge transporting structure and the mass of the polymerizable monomer having no charge transporting structure used in forming the protective layer.

The method for measuring the mass of the charge transporting material contained in the protective layer is as follows.

In the following explanation, the mass of a polymerizable monomer having a charge transporting structure contained in the protective layer of a photoreceptor is denoted by “a”, the mass of a polymerizable monomer having no charge transporting structure contained in the protective layer is denoted by “b”, and the mass of a charge transporting material contained in the protective layer is denoted by “f”.

First, in order to prepare a calibration curve, samples of the photoreceptor were prepared in which the value of the mass ratio (f/a) of the charge transporting material and the polymerizable monomer having the charge transporting structure was changed to 0%, 1%, 3%, 5%, and 10% by changing the amount of the charge transporting material added to a coating liquid for forming the protective layer with respect to the photoreceptor in which the ratio of the mass of the charge transporting material is to be calculated in advance.

For each sample, ToF-SIMS (Time-of-Flight Secondary Ion Mass Spectrometry) device (e.g., “PHI TRIFT V nanoTOF” (manufactured by ULVAC-PHI, Inc.) is used to scrape the surface of the photoreceptor by sputtering at a constant rate (e.g., sputtering rate: 0.02 μm/sec), and a fragment ratio (F_{F}/F_{A}) is obtained from an integrated value of a m/z value (F_{A}) caused by a chemical structure derived from a polymerizable monomer having a charge transporting structure and a m/z value (F_{F}) caused by a chemical structure derived from a charge transporting material.

The calibration curve is prepared in advance using the mass ratio (f/a) and the fragment ratio (F_{F}/F_{A}) described above.

When actually calculating the ratio of the mass of the charge transporting material, the above ToF-SIMS is used to scrape the surface of the photoreceptor by sputtering at a constant rate (e.g., sputtering rate: 0.02 μm/sec), and the fragment ratio (F_{F}/F_{A}) in the protective layer is calculated by measuring the mass spectrometric peak strength of the charge transporting material and the polymerizable monomer having the charge transporting structure in the measurement area (the protective layer in the present invention) along the thickness direction of the photoreceptor.

Further, based on the calculated fragment ratio (F_{F}/F_{A}), the mass ratio (f/a) is obtained using a calibration curve prepared in advance.

In the production of the photoreceptor, a polymerizable monomer having a charge transporting structure and a polymerizable monomer having no charge transporting structure have a value (a/b) of the mass ratio of the content in the protective layer determined from the amount contained in the coating liquid for forming the protective layer, and therefore, the ratio of the mass (MC_{CT} [%]) of the charge transporting material contained in the protective layer can be calculated using the value (a/b) of the mass ratio and the value (f/a) of the mass ratio.

### (1.3) Solvent

### (1.3.1) Solvent Used in Forming Protective Layer

It is preferable that the photosensitive layer contains a solvent having a solubility parameter of 10[cal/cm³)^{1/2}] or more and a molecular structure of 4 or more carbon atoms from the viewpoint of controlling the transfer amount of the charge transporting material from the charge transporting layer to the protective layer.

Examples of the solvent include 2-butanol (SP value: 11.4, carbon number: 4), pentanol (SP value: 11.5, carbon number: 5), and n-hexanol (SP value: 10.7, carbon number: 6).

In particular, the solvent preferably contains 2-butanol from the viewpoint of controlling the transfer amount of the the charge transporting material from the charge transporting layer to the protective layer.

The solvent is a solvent contained in a coating liquid for forming a protective layer used in forming a protective layer included in the electrophotographic photoreceptor of the present invention.

### (Control Method of Content of Charge Transporting Material of Protective Layer)

### [Control by Type, Amount, Ratio, and the Like of Solvent]

The amount of the charge transporting material diffused and transferred to the protective layer can be controlled by the type, amount, ratio, and the like of the solvent.

Specifically, for example, when 2-butanol is used as the solvent, the amount of the charge transporting material diffused and transferred to the protective layer can be controlled by adding tetrahydrofuran.

The charge transporting material is easily dissolved in tetrahydrofuran and hardly dissolved in 2-butanol, so that the amount or ratio of the tetrahydrofuran to be added to 2-butanol is increased.

As a result, the amount of the charge transporting material dissolved in the tetrahydrofuran increases, and thus the amount of the charge transporting material transferred from the charge transporting layer to the protective layer also increases.

### [Control by Drying Conditions, Curing Conditions, and the Like]

The amount of the charge transporting material diffused and transferred from the charge transporting layer to the protective layer can also be controlled by drying conditions in forming the intermediate layer, the charge generating layer, the charge transporting layer, and the protective layer, ultraviolet irradiation conditions in curing the protective layer, and the like.

Specifically, for example, by setting the drying condition in forming the charge transporting layer to a higher temperature, the solvent (tetrahydrofuran, toluene, and the like) contained in a coating liquid for forming a charge transporting layer is easily volatilized

As a result, when the coating liquid for forming a protective layer is applied on the charge transporting layer, the components in the coating liquid for forming a protective layer and the component in the charge transporting layer are less likely to mix, and the transfer amount of the charge transporting material to the protective layer is reduced.

In addition to the above-described control method, it can be controlled by intentionally adding as protective layer-containing components in order to achieve a desired amount.

(1.3.2) Solvent Contained in Photosensitive Layer after Forming Protective Layer

A part of the amount of the solvent used for forming the protective layer remains in the protective layer even after forming the protective layer, but a part thereof is transferred to the charge transporting layer, as the protective layer is adjacent to the charge transporting layer.

Since it is difficult to determine whether or not the above solvent is actually detected from the photosensitive layer and contained in the protective layer, in the present invention, the solvent contained in the photosensitive layer is detected.

A method for detecting a solvent (e.g., 2-butanol) contained in the photosensitive layer is described below.

### (Method for Detecting Solvent Contained in Photosensitive Layer)

Although a part of the amount of the solvent in the coating liquid for forming a protective layer remains in the protective layer even after forming the protective layer, various analysis methods conventionally used in general can be used as a detection method of the solvent.

For example, it can be detected using gas chromatography/mass spectrometry (also referred to as “GCMS”).

The solubility parameter of the solvent will be described later.

### (1.4) Inorganic Fine Particles

The protective layer according to the present invention preferably contains inorganic fine particles, whereby the wear resistance of the protective layer can be further improved.

The number average primary particle size of the inorganic fine particles is preferably within a range of 1 to 300 nm, and particularly preferably within a range of 3 to 100 nm, for example.

The particle size (number average primary particle size) of the inorganic fine particles is calculated as follows.

A magnified photograph of 10000 times is taken by a scanning electron microscope (manufactured by JEOL Ltd.), and 300 particles are randomly taken by a scanner to capture a photographic image (aggregated particles were excluded).

The above photographic images are binarized using an automated image-processing analyzer “LUZEX (registered trademark) AP” (manufactured by Nireco Corporation) software Ver.1.32 to calculate the horizontal Ferret diameter, respectively, and the average is calculated as the number average primary particle size.

Here, the horizontal Ferret diameter refers to the length of the side of the circumscribed rectangle parallel to the x-axis when the image of the inorganic fine particles is binarized.

The content ratio of the inorganic fine particles in the protective layer forming composition is preferably within a range of 1 to 100 parts by mass, and more preferably within a range of 5 to 80 parts by mass, with respect to 100 parts by mass of the total amount of the polymerizable monomer having a charge transporting structure and the polymerizable monomer having no charge transporting structure.

As described above, in the present invention, the “protective layer forming composition” is a component of a polymerizable monomer having a charge transporting structure, a polymerizable monomer having no charge transporting structure, a polymerization initiator, or the like.

However, in the present specification, a solvent is not included in the “protective layer forming composition”.

The above “protective layer forming composition” may contain other components as long as the effects of the present invention are not impaired.

Examples of other components include inorganic fine particles, lubricious organic fine particles, antioxidants, stabilizers, and silicone oils.

When the content ratio of the inorganic fine particles is within the above range, it is possible to sufficiently satisfy the hardness and the light transmittance of the protective layer.

When the content ratio of the inorganic fine particles is 1 part by mass or more, further wear resistance can be obtained by improving the hardness of the protective layer.

When the content ratio is 100 parts by mass or less, an influence on latent image formation due to a decrease in the light transmittance and an image defect caused by aggregation of inorganic fine particles are less likely to occur.

### (Metal Oxide Particles)

The above inorganic fine particles are preferably metal oxide particles from the viewpoint of wear resistance.

Examples of the metal oxide particles include particles made of a metal oxide such as silica (silicon dioxide), magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, and vanadium oxide.

Among them, silica particles or tin oxide particles are preferable from the viewpoint of hardness and light transmittance of the protective layer.

In addition, the metal oxide particles are preferably silica (SiO₂) particles from the viewpoint of increasing the surface hardness of the photoreceptor and improving the wear resistance by dispersing SiO₂ particles having high hardness.

The above metal oxide particles are preferably metal oxide particles surface-modified by a surface modifying agent so as to obtain a surface having a functional group that reacts with a polymerizable monomer including a polymerizable monomer having a charge transporting structure and a polymerizable monomer having no charge transporting structure.

Thus, the surface-modified metal oxide particles can react with the polymerizable monomer during the formation of the protective layer.

Therefore, the metal oxide particles are fixed to the matrix, and a stronger protective layer can be formed.

### [Surface Modification]

It is preferable that the metal oxide particles are surface-modified with a surface modifying agent having a radically polymerizable group from the viewpoint of forming a dense three-dimensional network and improving the crosslinking density.

It is more preferable that the metal oxide particles are surface-modified with a surface modifying agent having an acrylic group or a methacrylic group from the viewpoint of forming a dense three-dimensional network and improving the crosslinking density.

The surface modifying agent preferably has a functional group that reacts with a hydroxy group on the surface of the metal oxide particle in addition to the functional group that reacts with the polymerizable monomer.

Examples of the functional group that reacts with a hydroxy group on the surface of the metal oxide particle include a hydrolyzable silyl group.

Examples of such a surface modifying agent include a silane coupling agent and a titanium coupling agent.

For example, when the polymerizable group of the polymerizable monomer is an addition-polymerizable functional group, a silane coupling agent having an addition-polymerizable functional group and a hydrolyzable silyl group is preferably used as the surface modifying agent.

Examples of such a surface modifying agent include the compounds described below.
S-1 CH₂═CHSi(CH₃)(OCH₃)₂
S-2 CH₂═CHSi(OCH₃)₃
S-3 CH₂═CHSiCl₃
S-4 CH₂═CHCOO(CH₂)₂Si(CH₃)(OCH₃)₂
S-5 CH₂═CHCOO(CH₂)₂Si(OCH₃)₃
S-6 CH₂═CHCOO(CH₂)₃Si(CH₃)(OCH₃)₂
S-7 CH₂═CHCOO(CH₂)₃Si(OCH₃)₃
S-8 CH₂═CHCOO(CH₂)₂Si(CH₃)Cl₂
S-9 CH₂═CHCOO(CH₂)₂SiCl₃
S-10 CH₂═CHCOO(CH₂)₃Si(CH₃)Cl₂
S-11 CH₂═CHCOO(CH₂)₃SiCl₃
S-12 CH₂═C(CH₃)COO(CH₂)₂Si(CH₃)(OCH₃)₂
S-13 CH₂═C(CH₃)COO(CH₂)₂Si(OCH₃)₃
S-14 CH₂═C(CH₃)COO(CH₂)₃Si(CH₃)(OCH₃)₂
S-15 CH₂═C(CH₃)COO(CH₂)₃Si(OCH₃)₃
S-16 CH₂═C(CH₃)COO(CH₂)₂Si(CH₃)Cl₂
S-17 CH₂═C(CH₃)COO(CH₂)₂SiCl₃
S-18CH₂═C(CH₃)COO(CH₂)₃Si(CH₃)Cl₂
S-19 CH₂═C(CH₃)COO(CH₂)₃SiCl₃
S-20 CH₂═CHSi(C₂H₅)(OCH₃)₂
S-21 CH₂═C(CH₃)Si(OCH₃)₃
S-22 CH₂═C(CH₃)Si(OC₂H₅)₃
S-23 CH₂═CHSi(OCH₃)₃
S-24 CH₂═C(CH₃)Si(CH₃)(OCH₃)₂
S-25 CH₂═CHSi(CH₃)Cl₂
S-26 CH₂═CHCOOSi(OCH₃)₃
S-27 CH₂═CHCOOSi(OC₂H₅)₃
S-28 CH₂═C(CH₃)COOSi(OCH₃)₃
S-29 CH₂═C(CH₃)COOSi(OC₂H₅)₃
S-30 CH₂═C(CH₃)COO(CH₂)₃Si(OC₂H₅)₃

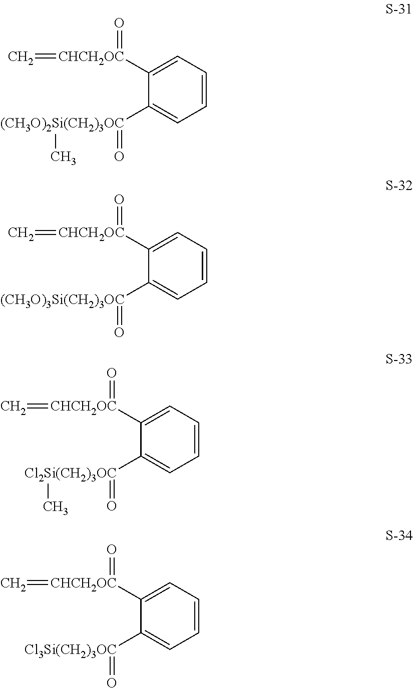

These surface modifying agents may be used alone or in combination of two or more.

The amount of the surface modifying agent to be used is not particularly limited, but is preferably within a range of 0.1 to 100 parts by mass with respect to 100 parts by mass of the metal oxide particles before modification, for example.

Specifically, the surface modification of the metal oxide particles can be performed by wet grinding a slurry (a suspension of solid particles) containing the metal oxide particles before modification and the surface modifying agent, thereby refining the metal oxide particles and simultaneously advancing the surface modification of the particles, and then removing the solvent to form a powder.

Examples of the apparatus used for the wet grinding of the slurry include a wet media dispersion type apparatus.

The “wet media dispersion type apparatus” is an apparatus having a step of filling beads as a medium in a container and rotating a stirring disk mounted perpendicular to a rotation axis at a high speed to crush and disperse aggregated particles of metal oxide particles.

As a configuration thereof, there is no problem as long as it can sufficiently disperse the metal oxide particles when the metal oxide particles are surface-modified and can be surface-modified.

For example, various types such as vertical type, horizontal type, continuous type, or batch type can be used.

Specifically, sand mill, ultra visco mill, pearl mill, grain mill, dyno-mill, agitator mill, dynamic mill, and the like can be used.

These dispersion type apparatuses are finely pulverized and dispersed by impact crushing, friction, shear, shearing stress, and the like using a pulverizing medium such as a ball or a bead.

As the beads used in the wet media dispersion type apparatus, for example, a ball made of glass, alumina, zircon, zirconia, steel, flint stone, or the like as a raw material can be used, and in particular, a ball made of zirconia or zircon is preferably used.

In addition, the size of the beads used is usually within a range of 1 to 2 mm in diameter, but in the present invention, it is preferable to use beads within a range of 0.1 to 1.0 mm, for example.

Various materials such as stainless steel, nylon, ceramic, or the like can be used for the disk or the inner wall of the container used in the wet media dispersion type apparatus, but in the present invention, the material for the disk or the inner wall of the container is preferably a ceramic such as zirconia or silicon carbide.

### (Lubricious Organic Fine Particles)

The protective layer forming composition may contain lubricious organic fine particles, whereby the wear resistance of the protective layer can be further improved.

As the lubricious organic fine particles, for example, fluorine atom-containing resin particles can be used. Preferably, one or two or more of the following are suitably selected as the fluorine atom-containing resin particles: ethylene tetrafluoride resin, tri-fluorinated ethylene chloride resin, tri-fluorinated ethylene propylene chloride resin, hexa-fluorinated ethylene propylene chloride resin, vinyl fluoride resin, vinylidene fluoride resin, di-fluoride ethylene di-chloride resin, and copolymers thereof.

Particularly preferred are ethylene tetrafluoride resin and vinylidene fluoride resin.

The lubricious organic fine particles have a number average primary particle size preferably in the range of 0.01 to 1 μm, particularly preferably in the range of 0.05 to 0.5 μm.

The number average primary particle size of the lubricious organic fine particles is measured by the same method as that of the inorganic fine particles.

The proportion of the lubricious organic fine particles in the protective layer forming composition is preferably in the range of 5 to 70 parts by mass, and more preferably in the range of 10 to 60 parts by mass, with respect to 100 parts by mass of the total amount of the above polymerizable monomers.

### (1.5) Layer Thickness

The layer thickness of the protective layer is preferably in the range of 0.2 to 10 μm, more preferably in the range of 0.5 to 6 μm.

As for the charge transporting layer, as will be described later, it is preferable that the total layer thickness of the charge transporting layer and the protective layer is within a range of 13 to 25 μm from the viewpoint of suppressing a decrease in wear resistance and nonuniform wear.

It is also preferable from the viewpoint of preventing cracks and film peeling.

The layer thickness of the protective layer can be calculated by measuring the layer thickness of the photosensitive layer and the layer thickness of the charge transporting layer with an eddy current type film thickness meter (manufactured by Fischer Instruments K. K.) or the like, and subtracting the layer thickness of the charge transporting layer from the layer thickness of the photosensitive layer.

### 2. Charge Transporting Layer

The charge transporting layer according to the present invention contains a charge transporting material.

The charge transporting layer is a layer containing a charge transporting material and a binder resin (hereinafter, also referred to as “binder resin for the charge transporting layer”).

When the charge transporting layer also serves as a charge generating layer, the charge transporting layer contains a charge generating agent described later.

The charge transporting layer may contain other components as necessary.

Examples of the other components include an inorganic filler, an antioxidant, an electronic conductive agent, a stabilizer, and a silicone oil.

The antioxidant is preferably disclosed in JP 2000-305291A, and the electronic conductive agent is preferably disclosed in JP S50-137543A and JP S58-76483A.

### (2.1) Charge Transporting Material

The charge transporting material according to the present invention is a compound having a function of transporting charge carriers (holes and electrons).

In addition, it is preferable that an absolute value of a difference in ionization potential between the polymerizable monomer having the charge transporting structure and the charge transporting material is equal to or less than 0.35 eV from the viewpoint of degradation resistance of the surface layer and hole injecting and transporting properties.

The ionization potential of the charge transporting material is a value unique to the material, and details of the ionization potential are as described above.

### (2.2) Layer Thickness

The layer thickness of the charge transporting layer varies depending on the characteristics of the charge transporting material, the characteristics and the content ratio of the binder resin for the charge transporting layer, and the like, but is preferably within a range of 5 to 40 μm.

More preferably, it is within a range of 10 to 30 μm.

### (Method for Measuring Layer Thickness)

The layer thickness of the charge transporting layer can be measured by an eddy current type film thickness meter (manufactured by Fischer Instruments K. K.) or the like.

### (2.3) Other

As the binder resin for the charge transporting layer, known resins can be used, and examples thereof include polycarbonate resins, polyacrylate resins, polyester resins, polystyrene resins, styrene-acrylonitrile copolymer resins, polymethacrylate ester resins, styrene-methacrylate copolymer resins and the like, but polycarbonate resins are preferred.

Further, polycarbonate resins of BPA (bisphenol A) type, BPZ (bisphenol Z) type, dimethyl BPA type, BPA-dimethyl BPA copolymer type, and the like are preferable from the viewpoint of crack resistance, wear resistance, and charging properties.

The content ratio of the charge transporting material in the charge transporting layer is preferably in the range of 10 to 500 parts by mass, and more preferably in the range of 20 to 250 parts by mass, with respect to 100 parts by mass of the binder resin for the charge transporting layer.

When the above content ratio is less than 10 parts by mass, electrical characteristics may be deteriorated, such as an increase in residual potential, and when the content ratio is more than 500 parts by mass, mechanical characteristics such as wear resistance may be deteriorated.

### 3. Charge Generating Layer

The charge generating layer according to the present invention contains titanyl phthalocyanine or a derivative thereof.

The charge generating layer contains a charge generating agent and a binder resin (hereinafter, also referred to as “binder resin for the charge generating layer”), and further contains other components as necessary.

### (3.1) Charge Generating Agent

As a charge generating agent in the present invention, it is preferable to use a titanyl phthalocyanine having a maximum peak at the Bragg angle)(20±0.2°) 27.3° in an X-ray diffraction spectrum using CuKα as a radiation source, or a derivative thereof.

Accordingly, it is possible to provide an electrophotographic photoreceptor having excellent sensitivity in a long wavelength range and further exhibiting stable properties without being influenced by a use environment, in particular, humidity.

In order to obtain an appropriate photosensitivity wavelength and sensitizing action, a charge generating agent other than the above may be mixed in the charge generating layer as another charge generating agent.

Examples of the charge generating agent other than the above include azo pigments such as Sudan red and Diane blue, quinone pigments such as pyrene quinone and anthranthrone, quinocyanine pigments, perylene pigments, indigo pigments such as indigo and thioindigo, polycyclic quinone pigments such as pyransuron and diphthaloylpyrene, and phthalocyanine pigments, but are not limited thereto.

Among them, polycyclic quinone pigments are preferred, and these charge generating agents may be used alone or as a mixture of two or more thereof.

### (3.2) Other

As the binder resin for the charge generating layer, known resins can be used, and examples thereof include polystyrene resins, polyethylene resins, polypropylene resins, acrylic resins, methacrylic resins, vinyl chloride resins, vinyl acetate resins, polyvinyl butyral resins, epoxy resins, polyurethane resins, phenolic resins, polyester resins, alkyd resins, polycarbonate resins, silicone resins, melamine resins, and copolymer resins containing two or more of these resins (for example, vinyl chloride-vinyl acetate copolymer resins, vinyl chloride-vinyl acetate-maleic anhydride copolymer resins), and poly-vinyl carbazole resins, but are not limited thereto. Among these, a polyvinyl butyral resin is preferable.

The content ratio of the charge generating agent in the charge generating layer is preferably within a range of 1 to 600 parts by mass with respect to 100 parts by mass of the binder resin for the charge generating layer.

More preferably it is in the range of 50 to 500 parts by mass.

The thickness of the charge generating layer varies depending on the characteristics of the charge generating agent, the characteristics and the content ratio of the binder resin for the charge generating layer, and the like, but is preferably within a range of 0.01 to 5 μm.

More preferably, it is in the range of 0.05 to 3 μm.

### 4. Intermediate Layer

The intermediate layer has a function of enhancing barrier property or adhesiveness between the conductive support and the charge generating layer or the charge transporting layer which also serves as the charge generating layer.

In photoreceptor of the present invention, the intermediate layer is not an essential configuration, but it is preferable to provide the intermediate layer in view of various failure prevention and the like.

Such an intermediate layer is, for example, a layer containing a binder resin (hereinafter, also referred to as “binder resin for the intermediate layer”) and conductive particles or metal oxide particles as necessary.

Examples of the binder resin for the intermediate layer include casein, polyvinyl alcohol, nitrocellulose, ethylene-acrylic acid copolymer, polyamide resin, polyurethane resin, and gelatin.

Among these, alcohol-soluble polyamide resins are preferable.

The intermediate layer may contain various conductive particles or metal oxide particles for the purpose of resistance adjustment.

As the metal oxide particles, various metal oxide particles such as alumina, zinc oxide, titanium oxide, tin oxide, antimony oxide, indium oxide, bismuth oxide, and zirconium oxide can be used, for example. Composite metal oxide particles such as tin-doped indium oxide and antimony-doped tin oxide may be used.

The number average primary particle size of such metal oxide particles is preferably within the range of 10 to 300 nm, and more preferably within the range of 20 to 100 nm.

The conductive particles or the metal oxide particles may be used alone or in combination of two or more.

When two or more kinds are mixed, they may be in the form of a solid solution or fusion.

The content ratio of the conductive particles or the metal oxide particles is preferably in the range of 20 to 400 parts by mass, more preferably in the range of 50 to 350 parts by mass, with respect to 100 parts by mass of the binder resin.

The thickness of the intermediate layer is preferably in the range of 0.1 to 15 μm, more preferably in the range of 0.3 to 10 μm.

### 5. Conductive Support

The conductive support constituting the photoreceptor according to the embodiment of the present invention may be any support as long as it has conductivity.

Examples of the conductive support include metal such as aluminum, copper, chromium, nickel, zinc, and stainless steel formed into a drum or a sheet.

In addition, examples thereof include a plastic film obtained by laminating a metal foil made of a metal such as aluminum or copper, a plastic film obtained by vapor depositing aluminum, indium oxide, tin oxide, or the like, and a metal, a plastic film, a paper, or the like in which a conductive layer is provided by applying a conductive material alone or together with a binder resin.

### [II Manufacturing Method of Electrophotographic Photoreceptor]

The manufacturing method of an electrophotographic photoreceptor according to the present invention includes at least a step of forming the charge transporting layer and the protective layer using a coating liquid, wherein the coating liquid for forming a protective layer contains a solvent having a solubility parameter of 10[(cal/cm³)^{1/2}] or more and having a molecular structure of 4 or more carbon atoms.

As a result, the effects of the present invention are exhibited, and the problem can be solved.

The electrophotographic photoreceptor of the present invention can be manufactured, for example, by sequentially forming layers constituting a photoreceptor on a conductive support.

The formation of each layer is performed by a step of forming a coating film made of a coating liquid containing a solid content (or a raw material component thereof) and a solvent constituting each layer, and a step of curing the coating film.

A specific manufacturing method of the photoreceptor of the present invention will be described below by exemplifying the manufacturing method of the photoreceptor 1 shown in FIG. 1.

A photoreceptor 1 can be manufactured, for example, by performing steps (1) to (4) below.
Step (1): A step of forming an intermediate layer 102 by coating a coating liquid for forming an intermediate layer on a conductive support 101 and drying the coating liquid.
Step (2): A step of forming a charge generating layer 103 by coating a coating liquid for forming a charge generating layer on the surface of the intermediate layer 102 formed on the conductive support 101 and drying the coating liquid.
Step (3): A step of forming a charge transporting layer 104 by coating a coating liquid for forming a charge transporting layer on the surface of the charge generating layer 103 formed on the intermediate layer 102 and drying the coating liquid.
Step (4): A step of forming a protective layer 105 by coating a coating liquid for forming a protective layer on the charge transporting layer 104 to form a coating film and curing the coating film.

### <Step (1): Formation of Intermediate Layer>

In the intermediate layer 102, a coating liquid (hereinafter, also referred to as a “coating liquid for forming an intermediate layer”) is prepared by dissolving a binder resin for an intermediate layer in a solvent.

If necessary, conductive particles or metal oxide particles are dispersed in the coating liquid, and then the coating liquid is applied to the conductive support 101 to a predetermined thickness to form a coating film.

The intermediate layer 102 can be formed by drying the coating film.

### (Dispersing Means)

As the mean for dispersing the conductive particles or the metal oxide particles in the coating liquid for forming an intermediate layer, an ultrasonic disperser, a ball mill, a sand mill, a homomixer, or the like can be used, but is not limited thereto.

### (Coating Method)

Examples of the coating method of the coating liquid for forming an intermediate layer include known methods such as a dip coating method, a spray coating method, a spinner coating method, a bead coating method, a blade coating method, a beam coating method, and a slide hopper method (including a circular slide hopper method).

Note that the circular slide hopper method is a method used for the coating in which an outer peripheral surface of a cylindrical or columnar material is used as a surface to be coated.

Further, the circular slide hopper method can be used as a method of coating a coating liquid for forming an intermediate layer to an outer peripheral surface of a drum-shaped conductive support.

### (Drying Method)

The drying method of the coating film can be appropriately selected according to the type of the solvent and the thickness of the coating film, but thermal drying is preferable.

### (Solvent)

The solvent used in the step of forming the intermediate layer 102 may be any solvent as long as it disperses the conductive particles or the metal oxide particles satisfactorily and dissolves the binder resin for the intermediate layer.

Specifically, alcohol based solvents having 1 to 4 carbon atoms, such as methanol, ethanol, n-propyl alcohol, isopropyl alcohol, n-butanol, t-butanol, and sec-butanol, are preferable because they are excellent in solubility of the binder resin and the coating performance.

Further, in order to improve the storage stability and the dispersibility of the particles, the co-solvent which can be used in combination with the above solvent to obtain a preferable effect includes benzyl alcohol, toluene, methylene chloride, cyclohexanone, tetrahydrofuran, and the like.

### [Concentration of Binder Resin for Intermediate Layer]

The concentration of the binder resin for an intermediate layer in the coating liquid for forming an intermediate layer is appropriately selected in accordance with the thickness and the production speed of the intermediate layer 102.

### <Step (2): Formation of Charge Generating Layer>

In the charge generating layer 103, a coating liquid (hereinafter, also referred to as a “coating liquid for forming a charge generating layer”) is prepared by dispersing a charge generating agent in a solution in which a binder resin for a charge generating layer is dissolved in a solvent.

The coating liquid may be applied to the intermediate layer 102 to a certain thickness to form a coating film, and the coating film may be dried to form the charge generating layer 103.

### (Dispersing Means)

Examples of the means for dispersing the charge generating agent in the coating liquid for forming a charge generating layer include an ultrasonic disperser, a ball mill, a sand mill, and a homomixer, but are not limited thereto.

### (Coating Method)

Examples of the coating method of the coating liquid for forming a charge generating layer include known methods such as a dip coating method, a spray coating method, a spinner coating method, a bead coating method, a blade coating method, a beam coating method, a slide hopper method (including a circular slide hopper method).

### (Drying Method)

The drying method of the coating film can be appropriately selected according to the type of the solvent and the thickness of the coating film, but thermal drying is preferable.

### (Solvent)

Examples of the solvent used to form the charge generating layer 103 include toluene, xylene, methylene chloride, 1,2-dichloroethane, methyl ethyl ketone, cyclohexane, ethyl acetate, t-butylacetate, methanol, ethanol, propanol, butanol, methyl cellosolve, 4-methoxy-4-methyl-2-pentanone, ethyl cellosolve, tetrahydrofuran, 1-dioxane, 1,3-dioxolane, pyridine, and diethylamine, but are not limited thereto.

### <Step (3): Formation of Charge Transporting Layer>

In the charge transporting layer 104, a coating liquid (hereinafter, also referred to as a “coating liquid for forming a charge transporting layer”) in which a binder resin for a charge transporting layer and a charge transport agent are dissolved in a solvent is prepared.

The coating liquid may be applied to the charge generating layer 103 to a certain thickness to form a coating film, and the coating film may be dried to form the charge transporting layer 104.

### (Coating Method)

Examples of the coating method of the coating liquid for forming a charge transporting layer include known methods such as a dip coating method, a spray coating method, a spinner coating method, a bead coating method, a blade coating method, a beam coating method, a slide hopper method (including a circular slide hopper method).

### (Drying Method)

The drying method of the coating film can be appropriately selected according to the type of the solvent and the thickness of the coating film, but thermal drying is preferable.

However, the transfer amount of the charge transporting material according to the present invention from the charge transporting layer to the protective layer can also be controlled by the drying method, and therefore this must be taken into consideration.

For example, when the coating film is dried by natural drying at room temperature (e.g., 25° C.), the above-described transfer amount is larger as compared in a case where the coating film is dried at a high temperature (e.g., 120° C.).

### (Solvent)

Examples of the solvent used for forming the charge transporting layer 104 include toluene, xylene, methylene chloride, 1,2-dichloroethane, methyl ethyl ketone, cyclohexanone, ethyl acetate, butyl acetate, methanol, ethanol, propanol, butanol, tetrahydrofuran, 1,4-dioxane, 1,3-dioxolane, pyridine, and diethylamine, but are not limited thereto.

### <Step (4): Formation of Protective Layer>

The protective layer 106 is typically formed using a coating liquid (also referred to as a “coating liquid for forming a protective layer”) containing a protective layer forming composition.

As described above, in the present invention, the “protective layer forming composition” is a component of a polymerizable monomer having a charge transporting structure, a polymerizable monomer having no charge transporting structure, a polymerization initiator, or the like.

However, in the present specification, a solvent is not included in the above “protective layer forming composition”.

The above “protective layer forming composition” may contain other components as long as the effects of the present invention are not impaired.

Examples of other components include inorganic fine particles, lubricious organic fine particles, antioxidants, stabilizers, and silicone oils.

The coating liquid for forming a protective layer is prepared by dissolving or dispersing each component in the above protective layer forming composition in a solvent.

In the manufacturing method of an electrophotographic photoreceptor of the present invention, the solubility parameter of the above solvent is 10[(cal/cm³)^{1/2}] or more, and the solvent has a molecular structure of 4 or more carbon atoms.

When the surface-modified metal oxide particles are used as the protective layer forming composition, the surface-modified metal oxide particles are used by being dispersed in a solvent.

### (Dispersing Means)

Examples of the means for dispersing the surface-modified metal oxide particles in a solvent include an ultrasonic disperser, a ball mill, a sand mill, and a homomixer, but are not limited thereto.

### (Solvent)

In order to prepare the coating liquid for forming a protective layer, it is possible to use a solvent that can dissolve or disperse each component in the above protective layer forming composition, has a solubility parameter of 10[(cal/cm³)^{1/2}] or more, and has a molecular structure of 4 or more carbon atoms.

Examples of the solvent include 2-butanol (SP value: 11.4, carbon number: 4), pentanol (SP value: 11.5, carbon number: 5), and n-hexanol (SP value: 10.7, carbon number: 6).

In particular, it is preferable to contain 2-butanol as the solvent from the viewpoint of controlling the transfer amount of the charge transporting material from the charge transporting layer to the protective layer.

Examples of other solvents include methanol, ethanol, n-propyl alcohol, isopropyl alcohol, n-butanol, t-butanol, sec-butanol, benzyl alcohol, toluene, xylene, dichloromethane, methyl ethyl ketone, cyclohexane, ethyl acetate, butyl acetate, methyl cellosolve, ethyl cellosolve, 1,4-dioxane, 1,3-dioxolane, pyridine, and diethylamine, but are not limited thereto.

### [Solubility Parameter]

The solubility parameter δ (solubility parameter: SP value) is a physical property value that is a measure of the compatibility between materials, and is a value given by the following equation using the molecular aggregation energy E and the molecular volume V.

δ=(E/V)^{1/2}
δ: solubility parameter [(cal/cm³)^{1/2}]
E: molecular aggregation energy [cal/mol]
V: molecular volume [cm ³/mol]

In the present invention, as the solubility parameter of the solvent, δ_{H} (Hildebrand solubility parameter) described in Table 1b of the following publicly known literature A can be cited.

However, since a value whose unit is (MPa)^{1/2}(=(J/cm³^{1/2}) is described in Table 1b of the publicly known literature A, the value must be divided by 2.05 in order to convert the unit to (cal/cm³)^{1/2}.

Publicly known literature A: CRITICAL COMPILATION OF SCALES OF SOLVENT PARAMETERS. PART I. PURE, NON-HYDROGEN BOND DONOR SOLVENTS, Technical Report, J.-L. M. Abboud, R. Notario, Pure Appl. Chem., Vol.71, No.4, pp.645-718,1999.

### (Coating Method)

Examples of the coating method of the coating liquid for forming a protective layer include known methods such as a slide hopper method (including a circular slide hopper method), a dip coating method, a spray coating method, a spinner coating method, a bead coating method, a blade coating method, and a beam coating method.

Among these coating methods, a slide hopper method or a dip coating method is preferable.

As the coating apparatus by the slide hopper method, for example, a circular slide hopper type coating apparatus described in detail in JP 558-189061A or the like can be used.

### (Formation and Curing of Coating Film)

Next, the obtained coating liquid for forming a protective layer is applied to the surface of the charge transporting layer 104 formed in the step (3) to form a coating film.

Thereafter, the protective layer 105 can be formed by curing the coating film by reacting the reaction components in the coating film.

In addition to the polymerizable monomer, the reactive component may include a component such as metal oxide particles having a reactive organic group on the surface.

When the protective layer forming composition contains metal oxide particles having a reactive organic group on the surface, the polymerizable compound reacts with the reactive organic group on the surface of the metal oxide particles, and a strong bond is formed at the interface between the matrix and the metal oxide particles.

The coating film may be cured without being dried, but is preferably cured after being naturally dried or thermally dried.

However, the transfer amount of the charge transporting material according to the present invention from the charge transporting layer to the protective layer can be controlled by drying conditions, curing conditions, and the like, and therefore, it is necessary to take this into consideration.

For example, when the coating film is dried by natural drying at room temperature (25° C.), the above- described transfer amount is larger as compared in a case where the coating film is dried at a high temperature (for example, 120° C.).

### [Drying Conditions]

The drying conditions can be appropriately selected depending on the type of the solvent, the thickness of the coating film, and the like.

The drying temperature is preferably in the range from the room temperature (25° C.) to 180° C., particularly preferably in the range from 80 to 140° C.

The drying time is preferably from 1 to 200 minutes, particularly preferably from 5 to 100 minutes.

### [Curing Conditions]

In the curing treatment for curing the coating film, the coating film is irradiated with ultraviolet rays to generate radicals, and a polymerizable monomer having a charge transporting structure is subjected to a polymerization reaction.

Alternatively, when a protective layer forming composition contains a polymerizable monomer having no charge transporting structure, a polymerizable monomer having a charge transporting structure is polymerized together with the polymerizable monomer having no charge transporting structure.

When the protective layer forming composition contains a polymerizable monomer having no charge transporting structure, a three-dimensional network structure is introduced into the matrix of the obtained protective layer by forming a crosslinked bond by a crosslinking reaction and curing, thereby obtaining a protective layer having high crosslinking density, high hardness, and high elasticity.

As the ultraviolet light source, any light source that generates ultraviolet light can be used without limitation.

For example, a low-pressure mercury lamp, a medium-pressure mercury lamp, a high-pressure mercury lamp, an ultra-high-pressure mercury lamp, a carbon arc lamp, a metal halide lamp, a xenon lamp, a flash (pulse) xenon, or the like can be used.

The irradiation conditions vary depending on the respective lamp, but for example, the irradiation amount of ultraviolet rays is usually in the range of 5 to 500 mJ/cm², preferably in the range of 5 to 100 mJ/cm².

The power of the lamp is preferably in the range of 0.1 to 5 kW, particularly preferably in the range of 0.5 to 3 kW.

The irradiation time for obtaining the required amount of ultraviolet rays is preferably, for example, 0.1 second to 10 minutes, and more preferably 0.1 second to 5 minutes from the viewpoint of working efficiency.

In the step of forming the protective layer, drying can be performed before and after the irradiation with ultraviolet rays and during the irradiation with ultraviolet rays, and the timing of the drying can be appropriately selected by combining these.

Further drying may be performed after the irradiation with the above ultraviolet rays, and in this case, it is preferable to dry in a range of 50 to 150° C., and more preferable to dry in a range of 80 to 120° C. from the viewpoint of improving the charge transporting property.

### [III. Electrostatic Charge Image Developing Toner]

The electrophotographic image forming apparatus of the present invention is an electrophotographic image forming apparatus comprising a charger, an exposure device, a developing device and a transfer device, characterized in that it comprises the electrophotographic photoreceptor of the present invention.

The printing material used is preferably an electrostatic charge image developing toner, and the electrostatic charge image developing toner includes toner particles containing a binder resin.

In the present invention, the “toner particles” refers to toner base particles to which an external additive is added, and an aggregate of the toner particles is referred to as a toner.

Further, in the following description, when there is no particular need to distinguish between the toner base particles and the toner particles, they are simply referred to as “toner particles”.

The electrostatic charge image developing toner may contain a colorant, a mold release agent, a charge control agent, an external additive, and the like, if necessary.

### 6. Components of Toner

### (6.1) Binder Resin

As the binder resin constituting the toner, a thermoplastic resin is preferably used.

As such a binder resin, a binder resin generally used as a binder resin constituting a toner can be used without any particular limitation.

Specific examples thereof include a styrene resin, acrylic resins such as alkyl acrylates, and alkyl methacrylates, a styrene acrylic copolymer resin, a polyester resin, a silicone resin, an olefin resin, an amide resin, and an epoxy resin.

Among them, a styrene resin, an acrylic resin, a styrene acrylic copolymer resin, and a polyester resin are preferable from the viewpoint of having melting characteristics of low viscosity and high sharp melt property.

As the main resin, a styrene acrylic copolymer resin is preferably used in an amount of 50% or more. These may be used alone or in combination of two or more.

As the polymerizable monomer for obtaining the binder resin, for example, styrene-based monomers such as styrene, methyl styrene, methoxystyrene, butylstyrene, phenylstyrene, and chlorstyrene; acrylic acid ester-based monomers such as methyl acrylate, ethyl acrylate, butyl acrylate, and ethylhexyl acrylate; methacrylic acid ester-based monomers such as methyl methacrylate, ethyl methacrylate, butyl methacrylate, and ethylhexyl methacrylate; carboxylic acid-based monomers such as acrylic acid, methacrylic acid, and fumaric acid; and the like can be used.

These may be used alone or in combination of two or more.

The binder resin constituting the toner preferably has a glass transition temperature (Tg) of 30 to 50° C. from the viewpoint of low-temperature fixing.

When the glass transition temperature is within this range, low-temperature fixability and heat-resistant storage stability are improved.

The glass transition temperature of the binder resin can be measured using “Diamond DSC” (manufactured by Perkin Elmer Co., Ltd.).

The measurement procedure is as follows: 3.0 mg of the binder regin is sealed in an aluminium pan and placed in a holder. An empty aluminum pan is used for the reference.

The measured conditions are as follows: the measurement temperature is 0 to 200° C., the temperature rising rate is 10° C./min, and the temperature lowering rate is 10° C./min. The temperature is controlled by heating-cooling- heating (Heat-Cool-Heat), and the analysis is performed based on the data from the second heating (2nd. Heat).

The glass transition temperature is obtained by drawing an extension line of the baseline before the rise of the first endothermic peak and a tangent line indicating the maximum slope between the rising part of the first peak and the peak apex, and indicating the intersection point as the glass transition point.

The glass transition temperature (Tg) of the toner is measured by the same methods as described above using the measurement sample as the toner.

Further, the softening temperature of the binder resin is preferably in the range of 80 to 130° C., more preferably in the range of 90 to 120° C.

The softening temperature can be measured, for example, by a flow tester “CFT-500D” (manufactured by Shimadzu Corporation).

The softening temperature is measured, for example, as follows.

First, 1.1 g of the sample is placed in a Petri dish and flattened at the temperature of 20±1° C. and the relative humidity of 50±5% RH and let it stand for 12 hours or more.

Thereafter, a force of 3820 kg/cm² is applied by a molding machine “SSP-10A” (manufactured by Shimadzu Corporation) for 30 seconds to produce a cylindrical molded sample having a diameter of lcm.

Then, the molded sample under the environment of the temperature of 24±5° C. and the relative humidity of 50±20% RH is extruded from the hole of the cylindrical die (1 mm diameter×1 mm) using a flow tester “CFT-500D” (Shimadzu Corporation) from the end of the preheating using a piston of the diameter 1 cm, under the conditions of the load of 196N (20 kgf), the starting temperature of 60° C., the preheating time of 300 seconds, and the temperature rising rate of 6° C./min.

The temperature T_{Offset} of the offset method measured by the setting of the offset value of 5 mm in the melting temperature measuring method of the temperature rising method is defined as the softening temperature of the sample.

The softening temperature of the toner is measured using the sample as the toner in the same manner as described above.

### (6.2) Colorant

As the colorant constituting the toner base particles, a known inorganic or organic colorant can be used.

The addition amount of the colorant is in the range of 1 to 30% by mass, preferably in the range of 2 to 20% by mass, with respect to the total amount of the toner.

### (6.3) Mold Release Agent

The toner base particles may contain a mold release agent.

The mold release agent is not particularly limited, and examples thereof include hydrocarbon waxes such as polyethylene wax, oxidized polyethylene wax, and polypropylene wax, oxidized polypropylene wax, carnauba wax, fatty acid ester wax, sazole wax, rice wax, candelilla wax, jojoba oil wax, and beeswax.

The content ratio of the mold release agent in the toner base particles is usually within a range of 1 to 30 parts by mass, and more preferably within a range of 5 to 20 parts by mass, with respect to 100 parts by mass of the binder resin for forming toner base particles.

### (6.4) Charge Control Agent

The toner base particles may contain a charge control agent. Examples thereof include metal complexes of salicylic acid derivatives with zinc and aluminum (metal salicylic acid complexes), calixarene-based compounds, organoboron compounds, and fluorine-containing quaternary ammonium salt compounds.

The content ratio of the charge control agent in the toner base particles is usually within a range of 0.1 to 5.0 parts by mass with respect to 100 parts by mass of the binder resin.

### (6.5) External Additives

It is preferable that the toner particles contain a lubricant as an external additive from the viewpoint of improving wear resistance.

In addition to the lubricant, from the viewpoint of improving charging performance and fluidity as a toner, it is preferable to add fine particles such as known inorganic fine particles and organic fine particles as an external additive to the surface of the toner particles.

The lubricant used in the present invention is preferably a metal soap (fatty acid metal salt) from the viewpoint of improving wear resistance.

As such a metal soap (fatty acid metal salt), a salt of a metal selected from zinc, calcium, magnesium, aluminum, and lithium is preferable.

Among these, fatty acid zinc, fatty acid lithium or fatty acid magnesium are particularly preferable.

The fatty acid of the metal soap (fatty acid metal salt) is preferably a higher fatty acid having 12 to 22 carbon atoms.

When a fatty acid having 12 or more carbon atoms is used, generation of free fatty acids can be suppressed, and when the carbon number of the fatty acid is 22 or less, the melting point of the metal soap (fatty acid metal salt) does not become too high, and good fixability can be obtained.

The fatty acid is particularly preferably stearic acid, and the metal soap (fatty acid metal salt) particles used in the present invention are preferably zinc stearate particles, lithium stearate particles or magnesium stearate particles from the viewpoint of electrical polarity.

The content of the lubricant in the toner is preferably within a range of 0.01 to 0.5 parts by mass of the lubricant with respect to 100 parts by mass of the toner base particles.

Within this range, sufficient lubricity is obtained on the surface of the toner base particles.

As the inorganic fine particles, inorganic oxide fine particles such as silica, titania, or alumina are preferably used, and further, the inorganic fine particles are preferably hydrophobized by a silane coupling agent, a titanium coupling agent, or the like.

As the organic fine particles, polymers such as polystyrene, polymethyl methacrylate, and styrene-methyl methacrylate copolymer can be used.

The total added amount of the inorganic fine particles and the organic fine particles added is preferably in the range of 0.05 to 5 parts by mass, and more preferably in the range of 0.1 to 3 parts by mass, with respect to 100 parts by mass of the toner base particles.

In order to improve the polishing effect on the surface of the photoreceptor, it is preferable to add fine metal oxide fine particles having a high polishing effect to the toner particles according to the present invention.

The metal oxide fine particles having a high polishing effect are preferably silica fine particles, alumina fine particles, cerium oxide fine particles, calcium titanate fine particles, or strontium titanate fine particles having a number average primary particle size within a range of 100 to 300 nm.

Among these, calcium titanate fine particles or strontium titanate fine particles are particularly preferable.

Examples of the method of adding the external additive include a dry method in which the external additive is

added to the dried toner base particles by powder, and examples of the mixing device include a mechanical mixing device such as a Henschel mixer and a coffee mill.

7. Method for producing Toner base particles

The toner particles according to the present invention are obtained by adding an external additive to toner base particles, and examples of the method for producing the toner base particles include a kneading and pulverizing method, a suspension polymerization method, an emulsion aggregation method, a dissolution suspension method, a polyester elongation method, and a dispersion polymerization method.

Among these, an emulsion aggregation method is preferably employed from the viewpoint of uniformity of the particle size, controllability of the shape, and ease of forming a core-shell structure, which are advantageous for improving image quality and high stability.

The emulsion aggregation method is a method in which a dispersion liquid of resin fine particles dispersed by a surfactant or a dispersion stabilizer is mixed with a dispersion liquid of toner base particle constituent components such as colorant fine particles, if necessary, and aggregated by adding an aggregating agent until a desired particle size of the toner is obtained, and thereafter or simultaneously with the aggregation, fusion between resin fine particles is performed to control the shape, thereby producing toner base particles.

Here, the resin fine particles may optionally contain an internal additive such as a mold release agent or a charge control agent, or may be composite particles formed of a plurality of layers having two or more layers formed of resins having different compositions.

In addition, it is preferable to add different kinds of resin fine particles to form toner base particles having a core-shell structure at the time of aggregation from the viewpoint of toner structure design.

### 8. Developer

The developer is a material for visualizing a latent image on a photoreceptor, and is generally composed of a toner and a carrier.

The above-described toner particles can be used in the electrophotographic image forming apparatus of the present invention as a magnetic or non-magnetic one-component developer, or may be mixed with carrier particles and used as a two-component developer.

When the toner is used as a two-component developer, the carrier particles may be magnetic particles made of a conventionally known material such as metals such as iron, ferrite, and magnetite, and alloys of these metals with metals such as aluminum and lead, and ferrite particles are particularly preferable.

As the carrier particles, resin-coated carrier (coat carrier) particles in which the surface of the magnetic particles is coated with a coating agent such as a resin, or binder-type carrier particles obtained by dispersing a magnetic fine powder in a binder resin, or the like may be used.

The coating resin constituting the resin-coated carrier particles is not particularly limited, for example, an olefin resin, a styrene resin, a styrene-acrylic resin, an acrylic resin, a silicone resin, an ester resin, and a fluoro resin can be used.

Further, the binder resin constituting the binder-type carrier particles is not particularly limited, and known binder resins such as a styrene-acrylic resin, a polyester resin, a fluoro resin, and a phenol resin can be used.

Among these, resin-coated carrier particles coated with a styrene-acrylic resin or an acrylic resin are preferable from the viewpoint of chargeability and durability.

The volume average particle size of the carrier particles is preferably in the range of 20 to 100 μm, more preferably in the range of 25 to 80 μm, because a high-quality image is obtained and the adhesion of the carrier is suppressed.

The volume average particle size of the carrier particles can be measured typically by a laser diffraction type particle size distribution measuring device “HELOS” equipped with a wet disperser (manufactured by Sympatec GmbH).

### [IV. Electrophotographic Image Forming Apparatus]

The electrophotographic image forming apparatus comprising a charger, an exposure device, a developing device, and a transfer device of the present invention is characterized by comprising an electrophotographic photoreceptor of the present invention.

As a result, the effects of the present invention are exhibited, and the problem can be solved.

Hereinafter, a charger, an exposure device, a developing device, and a transfer device according to the present invention will be described, but an electrophotographic photoreceptor will not be described because it has been described above.

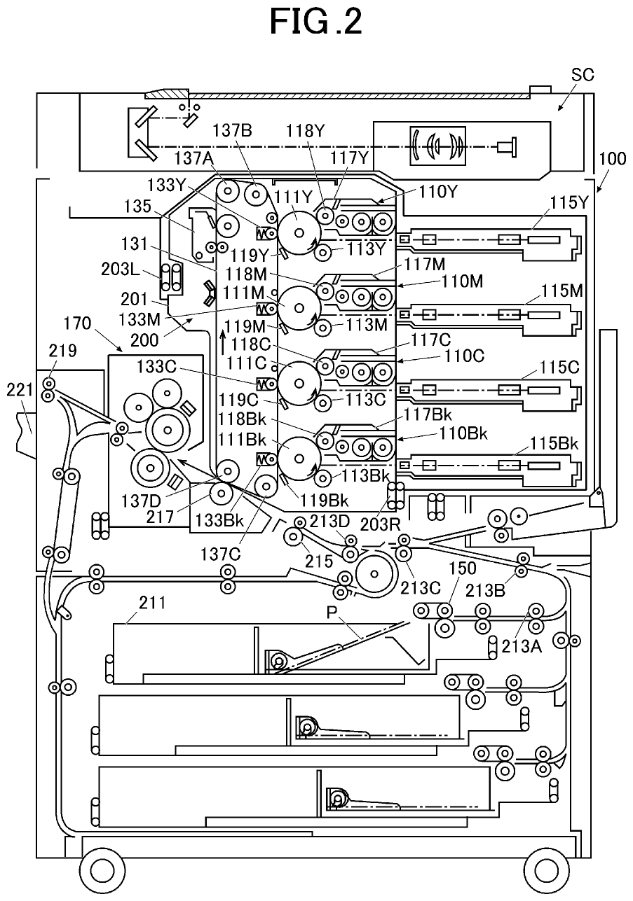

FIG. 2 is an explanatory cross-sectional view showing an exemplary configuration of an image forming apparatus according to the present invention.

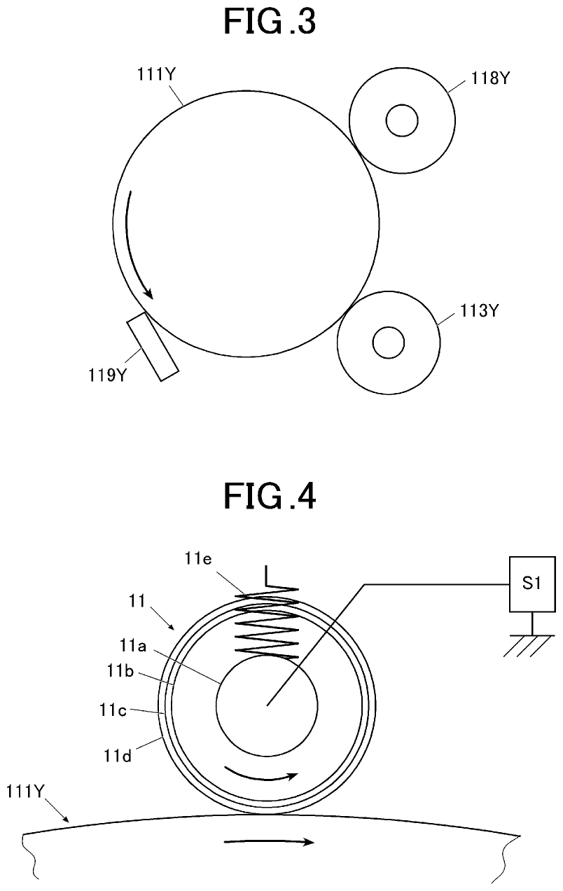

FIG. 3 is an explanatory cross-sectional view showing an exemplary configuration of a main part of an image forming apparatus according to the present invention.

An image forming apparatus 100 shown in FIG. 2 is referred to as a tandem type color image forming apparatus, and includes four sets of image forming units 110Y, 110M, 110C, and 110Bk, a paper conveyer 150, and a fixer 170.

A manuscript image reader SC is disposed on the upper part of the main body of the image forming apparatus 100.

The image forming units 110Y, 110M, 110C and 110Bk are vertically arranged side by side.

The image forming unit 110Y includes a rotating drum-shaped photoreceptor 111Y, a charger 113Y, an exposure device 115Y, a developing device 117Y, a primary transfer roller (a primary transfer device) 133Y, and a cleaner 119Y. The exposure device 115Y, the developing device 117Y, the primary transfer roller 133Y and the cleaner 119Y are sequentially arranged on the outer peripheral surface area along the rotation direction of the photoreceptor 117Y. The image forming unit 110M includes a rotating drum-shaped photoreceptor 111M, a charger 113M, an exposure device 115M, a developing device 117M, a primary transfer roller (a primary transfer device) 133M, and a cleaner 119M. The exposure device 115M, the developing device 117M, the primary transfer roller 133M and the cleaner 119M are sequentially arranged on the outer peripheral surface area along the rotation direction of the photoreceptor 117M. The image forming unit 110C includes a rotating drum-shaped photoreceptor 111C, a charger 113C, an exposure device 115C, a developing device 117C, a primary transfer roller (a primary transfer device) 133C, and a cleaner 119C. The exposure device 115C, the developing device 117C, the primary transfer roller 133C and the cleaner 119C are sequentially arranged on the outer peripheral surface area along the rotation direction of the photoreceptor 117C. Further, the image forming unit 110Bk includes a rotating drum-shaped photoreceptor 111Bk, a charger 113Bk, an exposure device 115Bk, a developing device 117Bk, a primary transfer roller (a primary transfer device) 133Bk, and a cleaner 119Bk. The exposure device 115Bk, the developing device 117Bk, the primary transfer roller 133Bk and the cleaner 119Bk are sequentially arranged on the outer peripheral surface area along the rotation direction of the photoreceptor 117Bk.

Toner images of yellow (Y), magenta (M), cyan (C), and black (Bk) are formed on the photoreceptors 111Y,

111M, 111C and 111Bk, respectively.

Hereinafter, each configuration other than the photoreceptor of the image forming apparatus will be described.

When the description is made with reference to the drawings, the description will be given by the example of an image forming unit 110Y.

### <Charger>

The charger is a device for uniformly charging the surface of the photoreceptor.

The charger includes a contact system such as a charging roller, a charging brush, and a charging blade, and a non-contact system such as a corona charger (corotron charger, strokoton charger, and the like).

The contact system has an advantage that the generation amount of harmful ozone gas associated with the charging process is small.

The non-contact system has an advantage that filming is less likely to occur because it is not a proximity discharge compared with the contact system.

The charger included in the image forming system of the present invention may be a contact system or a non- contact system.

The charger is preferably a proximity charging roller and a contact charging roller from the viewpoint that the generation amount of harmful ozone gas associated with the charging process is small and the image quality is improved and the size of the device is reduced.

The charger 113Y shown in FIGS. 2 and 3 is a contact system.

The charger 113Y in the example includes a charging roller disposed in contact with the surface of the photoreceptor 111Y and a power supply that applies voltage to the charging roller.

An example of the charger that is a contacting system will be described. FIG. 4 is a schematic diagram showing an exemplary configuration of a charger.

In the charging roller 11 shown in FIG. 4, a resistance control layer 11c is laminated on the surface of an elastic layer 11b laminated on the surface of a core metal 11a, and a surface layer 11d is laminated on the resistance control layer 11c. The elastic layer 11b is for obtaining uniform adhesion to the photoreceptor 111Y and reducing the charging noise by imparting elasticity. The resistance control layer 11c is for obtaining high-uniformity electric resistance of the charging roller 11 as a whole as needed. The charging roller 11 is energized (biased) in a direction of the photoreceptor 111Y by a pressing spring 11e and pressed against the surface of the photoreceptor 111Y by a specific pressing force whereby a charging nip part is formed, and the charging roller 11 is rotated following the rotation of the photoreceptor 111Y.

The core metal 11a is formed of, for example, a metal such as iron, copper, stainless steel, aluminum, and nickel, or a metal plated on the surface of these metals to obtain rust resistance and scratch resistance to the extent that the conductivity is not impaired, and the outer diameter of the core metal is set within a range of 3 to 20 mm, for example.

The elastic layer 11b is formed by adding conductive fine particles made of carbon black, carbon graphite, or the like, or conductive fine particles made of an alkali metal salt, an ammonium salt, or the like to an elastic material such as rubber.

Specific examples of the elastic material include natural rubber, synthetic rubbers such as ethylene propylene diene methylene rubber (EPDM), styrene-butadiene rubber (SBR), silicone rubber, urethane rubber, epichlorohydrin rubber, isoprene rubber (IR), butadiene rubber (BR), nitrile-butadiene rubber (NBR) and chloroprene rubber (CR), resins such as polyamide resins, polyurethane resins, silicone resins and fluororesins, and foams such as foamed sponges.

The elasticity can be adjusted by adding process oils, plasticizers, and the like into the elastic material.

The volume resistivity of the elastic layer 11b is preferably within 1×10¹ to 1×10¹⁰Ω·cm.

The volume resistivity of the elastic layer 11b is measured according to JIS K 6911.

The thickness of the elastic layer 11b is preferably in the range of 500 to 5000 μm, more preferably in the range of 500 to 3000 μm.

The resistance control layer 11c is provided with a charging roller 11 for the purpose of having a uniform electric resistance as a whole, but may not be provided.

The resistance control layer 11c can be provided by coating a material having a moderate conductivity or by covering it with a tube having a moderate conductivity.

Specific examples of the material constituting the resistance control layer 11c include materials in which conductive agents such as conductive fine particles made of carbon black, carbon graphite, and the like; conductive metal oxide fine particles made of conductive titanium oxide, conductive zinc oxide, conductive tin oxide, and the like; and conductive fine particles made of alkali metal salts, ammonium salts, and the like, are added in base materials of resins such as polyamide resins, polyurethane resins, fluororesins, and silicone resins; and rubbers such as epichlorohydrin rubber, urethane rubber, chloroprene rubber, and acrylonitrile-based rubber.

The volume resistivity of the resistance control layer 11c is preferably in the range of 1×10⁻² to 1×10¹⁴Ω·cm, and more preferably in the range of 1×10¹ to 1×10¹⁰Ω·cm.

The volume resistivity of the resistance control layer 11c is measured according to JIS K 6911.

The thickness of the resistance control layers 11c is preferably in the range of 0.5 to 100 μm, more preferably in the range of 1 to 50 μm, and even more preferably in the range of 1 to 20 μm.

The surface layer 11d is provided for the purpose of preventing bleeding out of the obtained charging roller of a plasticizer in the elastic layer 11b to the surface, for the purpose of obtaining the slipperiness and smoothness of the surface of the charging roller, or for the purpose of preventing leakage even when there is a defect such as a pinhole on the photoreceptor 111Y, and is provided by coating a material having a moderate conductivity or by covering it with a tube having a moderate conductivity.

When the surface layer 11d is provided by coating a material, specific materials include materials in which conductive agents such as conductive fine particles made of carbon black, carbon graphite, and the like and conductive metal oxide fine particles made of conductive titanium oxide, conductive zinc oxide, conductive tin oxide, and the like, are added in base materials of resins such as polyamide resins, polyurethane resins, acrylic resins, fluororesins, and silicone resins; and epichlorohydrin rubber, urethane rubber, chloroprene rubber, and acrylonitrile-based rubber.

Examples of the coating method include a dip coating method, a roll coating method, and a spray coating method.

When the surface layer 11d is provided by covering it with a tube, specific examples of the tube include tubes in which the above-described conductive agent is added to nylon 12, 4-fluoride ethylene-perfluoroalkyl vinyl ether copolymer resin (PFA), polyvinylidene fluoride, 4-fluoride ethylene-6-fluoride propylene copolymer resin (FEP); and a thermoplastic elastomer such as polystyrene-based, polyolefin-based, polyvinyl chloride-based, polyurethane-based, polyester-based, and polyamide-based, and then tubularly formed.

The tube may be heat shrinkable or non-heat shrinkable.

The volume resistivity of the surface layer 11d is preferably in the range of 1×10⁻² to 1×10¹⁴Ω·cm, more preferably 1×10⁻² to 1×10¹⁴Ω·cm.

The volume resistivity of the surface layer 11d is measured according to JIS K 6911.

The thickness of the surface layer 11d is preferably in the range of 0.5 to 100 μm, more preferably in the range of 1 to 50 μm, even more preferably in the range of 1 to 20 μm.

The surface roughness of the surface layer 11d is preferably in the range of 1 to 30 μm, more preferably in the range of 2 to 20 μm, and still more preferably in the range of 5 to 10 μm.

In the charging roller 11 as described above, the charging bias voltage is applied from the power supply S1 to the core metal 11a of the charging roller 11, so that the surface of the photoreceptor 111Y is charged to a predetermined potential of a predetermined polarity.

Here, the charging bias voltage may be, for example, only a DC voltage, but it is preferable that the charging bias voltage is an oscillation voltage in which an AC voltage is superimposed on the DC voltage because the uniformity of the charging is excellent.

### <Exposure Device>

The exposure device is a device for forming an electrostatic latent image corresponding to an image by performing exposure on a photoreceptor given a uniform potential by a charger based on an image signal.

Examples of the exposure device include a device of a LED with light-emitting elements arranged in an array in the axial direction of the photoreceptor and an imaging element, and a device of a laser optical system.

### <Developing Device >

The developing device (developer) is a device for forming a toner image by supplying a developer to a surface of a photoreceptor to develop an electrostatic latent image formed on the surface of the photoreceptor.

The above developer used was the same as the developer described for the electrostatic image developing toner.

The developing device may be provided with a lubricant supplier for supplying a lubricant to the developer, and it is preferable that the developer supplied by the developing device contains a lubricant from the viewpoint of improving wear resistance.

It is more preferable that the lubricant is a metal soap from the viewpoint of improving wear resistance.

Specifically, the developing device 117Y shown in FIG. 2 includes a developing roller 118Y that contains a magnet and rotates while holding a developer, and a voltage application device (not shown) that applies a DC and/or AC bias voltage between the photoreceptor 111Y and developing roller 118Y.

The developer is conveyed to the photoreceptor 111Y by rotating the developing roller 118Y.

A toner thin layer on the developing roller 118Y then contacts the photoreceptor 111Y to develop the electrostatic latent image on the photoreceptor 111Y.

The developing roller 118Y is connected to the voltage application device.

A DC and/or AC bias voltage is applied to the developing roller 118Y by the voltage application device.

By controlling the voltage applied to the developing roller 118Y, the developing bias can be adjusted to a desired value.

A potential difference (development potential difference) between the developing roller 118Y and the potential of the electrostatic latent image carried by the photoreceptor 111Y forms an electric field in a developing section where the developing roller 118Y and the photoreceptor 111Y face each other.

The toner in the developer conveyed to the developing section by rotating the developing roller 118Y moves by the action of the force received from the electric field, and is attracted to the electrostatic latent image on the photoreceptor 111Y.

When the electrostatic latent image carried on the photoreceptor 111Y is visualized, a toner image corresponding to the shape of the electrostatic latent image is formed on the surface of the photoreceptor 111Y.

### <Transfer Device>

The transfer device is a device for transferring a toner image on a photoreceptor to a transfer body (intermediate transfer body or transfer material).

When an intermediate transfer body is used, a primary transfer roller is the transfer device.

Since the “transfer device” in the present invention is a means for transferring the “toner image on the photoreceptor”, the “transfer device” does not include a secondary transfer roller used for transferring from the intermediate transfer body to the transfer material.

The primary transfer roller 133Y shown in FIG. 2 transfers a toner image formed on the photoreceptor 111Y to an intermediate transfer body 131 with endless belt shape.

The primary transfer roller 133Y is disposed in contact with the intermediate transfer body 131.

In the image forming apparatus 100 shown in FIG. 2, an intermediate transfer method in which toner images formed on photoreceptors 111Y, 111M, 111C, and 111Bk are transferred to an intermediate transfer body 131 by primary transfer rollers (primary transfer devices) 133Y, 133M, 133C, and 133Bk and the respective toner images transferred onto the intermediate transfer body 131 are transferred to a transferred material P by a secondary transfer roller (secondary transfer device) 217 is adopted, but a direct transfer method in which a toner image formed on a photoreceptor is directly transferred to a transfer material P by the transfer device may be adopted.

### EXAMPLES

Hereinafter, the present invention will be described in detail with reference to Examples, but the present invention is not limited thereto. In the examples, “part” or “%” is used, but unless otherwise specified, “part by mass” or “% by mass” is indicated.

### A. Preparation of Photoreceptor

### (A.1) Preparation of Photoreceptor 1

### (A.1.1) Preparation of Conductive Support

The surface of a cylindrical aluminum support having a diameter of 30 mm was cut, and a conductive support having a surface roughness Rz=1.5 μm was prepared.

### (A.1.2) Formation of Intermediate Layer

The following components [1] were mixed in the following amounts, and dispersed for 10 hours in a batch manner using a sand mill as a disperser to prepare a coating liquid for forming an intermediate layer.

### <Components [1]>

| | | |
|---|---|---|
| Polyamide resin | 1 | part by mass |
| Titanium Oxide | 3 | parts by mass |
| Methanol | 20 | parts by mass |

As the polyamide resin in the components [1], “CM8000” (manufactured by Toray Industries, Inc.) was used.

In addition, as the titanium oxide particles in Components [1], “SMT500SAS” (manufactured by Tayca Co., Ltd.) was used.

After standing it overnight, the solution was filtered using a Rigimesh 5 μm filter (manufactured by Nihon Pall Ltd.) to prepare a coating liquid for forming an intermediate layer.

The coating liquid for forming an intermediate layer was applied on a conductive support by a dip coating method so that the thickness after drying was 2 μm, thereby forming an intermediate layer.

### (A.1.3) Formation of Charge Generating Layer

The following components [2] were mixed in the following amounts, and dispersed for 10 hours using a sand mill to prepare a coating liquid for forming a charge generating layer.

### <Components [2]>

| | | |
|---|---|---|
| Charge generating material | 20 | parts by mass |
| Polyvinyl butyral resin | 10 | parts by mass |
| t-butyl acetate | 700 | parts by mass |
| 4-methoxy-4-methyl- | 300 | parts by mass |
| 2-pentanone (mixed solvent) | | |

The charge generating material in the components [2] is a titanyl phthalocyanine pigment having a maximum diffraction peak at a position of at least 27.3° by Cu-Kα characteristic X-ray diffraction spectroscopy.

In addition, as the polyvinyl butyral resin in the components [2], “#6000-C” (manufactured by Denka Company Limited) was used.

The coating liquid for forming a charge generating layer was applied on the intermediate layer by a dip coating method so that the thickness after drying was 0.3 μm, and air-dried (dried at 25° C. for 30 minutes) to form a charge generating layer.

### (A.1.4) Formation of Charge Transporting Layer

The following components [3] were mixed in the following amounts, and the dissolved coating liquid for forming a charge transporting layer was applied on the charge generating layer by a dip coating method so that the thickness after drying under the following drying conditions was 18 μm, thereby forming a charge transporting layer.

### (Drying Conditions)

It was dried at a temperature of 120° C. for 60 minutes.

### <Components [3]>

| | | |
|---|---|---|
| Polycarbonate resin (binder resin) | 100 | parts by mass |
| Charge transporting material (compound F) | 50 | parts by mass |
| Antioxidant | 2 | parts by mass |
| Tetrahydrofuran | 540 | parts by mass |
| Toluene | 135 | parts by mass |
| Silicone oil | 0.3 | parts by mass |

As the polycarbonate resin in the components [3], a polycarbonate resin “Z-300” (solubility parameter “δ_{B}=9.9”) which is a copolymer of bisphenol Z (manufactured by Mitsubishi Gas Chemical Company Inc.) was used.

As the antioxidant in the components [3], “Irganox1010” (manufactured by BASF Japan Co., Ltd.) was used.

As the silicone oil in the components [3], “KF-54” (manufactured by Shin-Etsu Chemical Co., Ltd.) was used.

### (A.1.5) Formation of Protective Layer

The following components [4] were mixed and stirred, sufficiently dissolved and dispersed to prepare a coating liquid for forming a protective layer.

### <Components [4 ]>

| | | |
|---|---|---|
| 2-butanol (solvent 1) | 140 | parts by mass |
| Tetrahydrofuran (solvent 2) | 60 | parts by mass |
| Polymerizable monomer having a | 50 | parts by mass |
| charge transporting structure (compound A) | | |
| Polymerizable monomer having no | 50 | parts by mass |
| charge transporting structure | | |
| Photopolymerization initiator | 5 | parts by mass |

As the polymerizable monomer having no charge transporting structure in the components [4], “SR350” (manufactured by Sartomer), which is a polymerizable monomer having three or more functional groups, was used.

This is trimethylolpropane trimethacrylate, represented by the chemical structural formula Ml.

In addition, as the photopolymerization initiator, “Omnirad819” (manufactured by IGM Resins B.V.) was used.

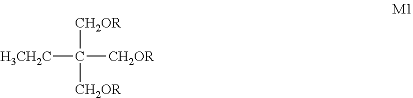

[In the above formula, R represents an acryloyl group (CH₂═CHCO—).]

The prepared coating liquid for forming a protective layer was applied onto the charge transporting layer using a circular slide hopper coating apparatus so that the thickness after drying was 3 μm.

Next, a photoreceptor 1 was prepared by irradiating UV light using a metal halide lamp for 1 minute and then drying at 110° C. for 70 minutes to form a protective layer.

### (A.1.6) Measurement of Total Layer Thickness of Charge Transporting Layer and Protective Layer

An eddy current type film thickness meter (manufactured by Fischer Instruments K. K.) was used to measure the total layer thickness of the charge transporting layer and the protective layer.

### (A.1.7) Calculation of Mass Ratio of Charge Transporting Material

The ratio of the mass (M_{CT} [%]) of the charge transporting material contained in the protective layer is represented by the following Equation (1).

M_{CT}[%]=(mass of a charge transporting material contained in the protective layer)/(mass of a charge transporting material contained in the protective layer+mass of a reactant of a polymerizable monomer having a charge transporting structure and a polymerizable monomer having no charge transporting structure)×100. Equation (1)

In the present invention, the “mass of a reactant of a polymerizable monomer having a charge transporting structure and a polymerizable monomer having no charge transporting structure” is defined as the total amount of the mass of the polymerizable monomer having a charge transporting structure and the mass of the polymerizable monomer having no charge transporting structure used in forming the protective layer.

The calculation method was performed as follows.

In the following explanation, the mass of the polymerizable monomer having the charge transporting structure contained in the protective layer of a photoreceptor is denoted by “a”, the mass of the polymerizable monomer having no charge transporting structure contained in the protective layer is denoted by “b”, and the mass of the charge transporting material contained in the protective layer is denoted by “f”.

First, in order to prepare a calibration curve, with respect to photoreceptor 1 for calculating a mass ratio of the charge transporting material in advance, samples of the photoreceptor in which the mass ratio value (f/a) of the charge transporting material and the polymerizable monomer having the charge transporting structure was changed to 0%, 1%, 3%, 5%, and 10% by changing the amount of the charge transporting material added to a coating liquid for forming the protective layer were prepared.

For each sample, ToF-SIMS (Time-of-Flight Secondary Ion-Mass Spectrometry) device (e.g., “PHI TRIFT V nanoTOF” (manufactured by ULVAC-PHI, Inc.)) was used to scrape the surface of the photoreceptor 1 at a constant rate (e.g., sputtering rate: 0.02 μm/sec) by sputtering, and the fragment ratio (F_{F}/F_{A}) was determined from the integrated value of m/z value (F_{A}) caused by the chemical structure derived from the polymerizable monomer having a charge transporting structure and m/z value (F_{F}) caused by the chemical structure derived from the charge transporting material.

The calibration curve was prepared in advance using the mass ratio (f/a) and the fragment ratio (F_{F}/F_{A}) described above.

When actually calculating the ratio of the mass of the charge transporting material, the above ToF-SIMS was used to scrape the surface of the photoreceptor by sputtering at a constant rate (e.g., the sputtering rate: 0.02 μm/sec), and the fragment ratio (F_{F}/F_{A}) in the protective layer was calculated by measuring the mass spectrometric peak strength of the charge transporting material and the polymerizable monomer having a charge transporting structure in the measurement area (the protective layer of the present invention) along the thickness direction of the photoreceptor.

Further, based on the calculated fragment ratio (F_{F}/F_{A}), the mass ratio value (f/a) was determined using the calibration curve prepared in advance.

In preparing the photoreceptor, a polymerizable monomer having a charge transporting structure and a polymerizable monomer having no charge transporting structure have a mass ratio value (a/b) of the content in the protective layer determined from the amount to be contained in the coating liquid for forming the protective layer, and therefore, the ratio of the mass (M_{CT} [%]) of the charge transporting material contained in the protective layer was calculated using the mass ratio value (a/b) and the mass ratio value (f/a), and(M_{CT} [%])=3.1%.

In the photoreceptor 1, m/z value (F_{F}) caused by the chemical structure derived from the charge transporting material (compound F) contained in the protective layer was set to 451, and m/z value (F_{A}) caused by the chemical structure derived from the polymerizable monomer (compound A) having the charge transporting structure contained in the protective layer was set to 418.

(A.1.8) Detection of Solvent contained in Photosensitive Layer

Gas Chromatography/Mass Spectrometry (also referred to as “GCMS”) was used to detect the solvent contained in the photosensitive layer.

The entire photosensitive layer was peeled from the photoreceptor 1 to prepare a sample.

Approximately 100 mg of the sample was sealed in a vial, heated at 120° C. for 30 minutes, and then subjected to qualitative and quantitative determination of 2-butanol (solvent 1) with “SH-I-624Sil MS” manufactured by Shimadzu Corporation under the following conditions.

### <Conditions>

Internal diameter of the column : 0.25 mm i.d.
Length of the column: 30 m
Film thickness of liquid phase in the column: 1.40 μm

Consequently, 4 mg/kg of 2-butanol (solvent 1) was detected.

In the present invention, when a solvent “2-butanol (solvent 1)” having a solubility parameter of 10[(cal/cm³)^{1/2}] or more and a molecular structure of 4 or more carbon atoms is used in the coating liquid for forming a protective layer, it was confirmed that the solvent can be detected from the photosensitive layer as described above.

### (A.2) Preparation of Photoreceptors 2 to 6 and 11 to 20

Preparation of the conductive support and formation of the intermediate layer were the same as in the photoreceptor 1.

Charge generating layers, charge transporting layers, and protective layers of photoreceptors 2 to 6 and 11 to were formed in the same manner as in the photoreceptor 1, except that the type of the charge generating agent, the drying conditions of the charge transporting layer, and various conditions regarding the components contained in the coating liquid for forming the protective layer were changed as shown in Table III.

The total layer thickness of the charge transporting layer and the protective layer and the ratio of the mass of the charge transporting material were measured, and the solvent contained in the protective layer was detected, in the same manner as in the photoreceptor 1.

The charge generating agents described in the columns of the charge generating agents in Table III are as follows.
TiOPc: titanyl phthalocyanine pigment
TiOPc (diol type): diol-added titanyl phthalocyanine pigment
GaCIPc: chlorogallium phthalocyanine pigment
Bisazo: bisazo pigment

The chemical structural formulae of the charge generating materials are shown below.

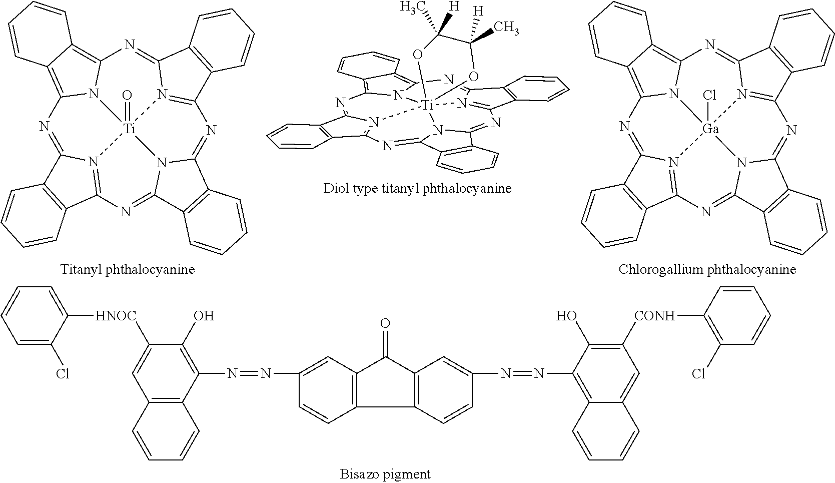

### (Description Method of Various Conditions Regarding Components Contained in Coating Liquid for Forming Protective Layer)

The “various conditions regarding the components contained in the coating liquid for forming a protective layer” in preparing the photoreceptor described above are the type of the solvent in the coating liquid for forming a protective layer, the content thereof, the type of the polymerizable monomer (monomer 1 in Table III) having a charge transporting structure, the type of the polymerizable monomer (monomer 2 in Table III) having no charge transporting structure, the type of the charge transporting material, and the mass ratio M_{CT}.

As described above, the MCT is represented by the following equation (1).

M_{CT}[%]=(mass of a charge transporting material contained in the protective layer)/(mass of a charge transporting material contained in the protective layer+mass of a reactant of a polymerizable monomer having a charge transporting structure and a polymerizable monomer having no charge transporting structure)×100. Equation (1)

The ratio of the mass M_{CT} [%] of a charge transporting material contained in the protective layer=(mass of a charge transporting material)/(mass of a charge transporting material+mass of a reactant)×100.

In the present invention, the “mass of a reactant of a polymerizable monomer having a charge transporting structure and a polymerizable monomer having no charge transporting structure” is defined as the total amount of the mass of a polymerizable monomer having a charge transporting structure and the mass of a polymerizable monomer having no charge transporting structure.

In the columns of the solvent type in Table III, when “2-BuOH” is indicated, the solvent represents “2-butanol”, and when “THF” is indicated, the solvent represents “tetrahydrofuran”.

The chemical structural formulae of the polymerizable monomer (monomer 1) having a charge transporting structure in Table III are shown below. In addition, the ionization potentials (IP₁) thereof are also shown in Tables I.

For example, when “A” is indicated in the column of the monomer 1 in Table III, the monomer represents the chemical structural formula of compound A below.

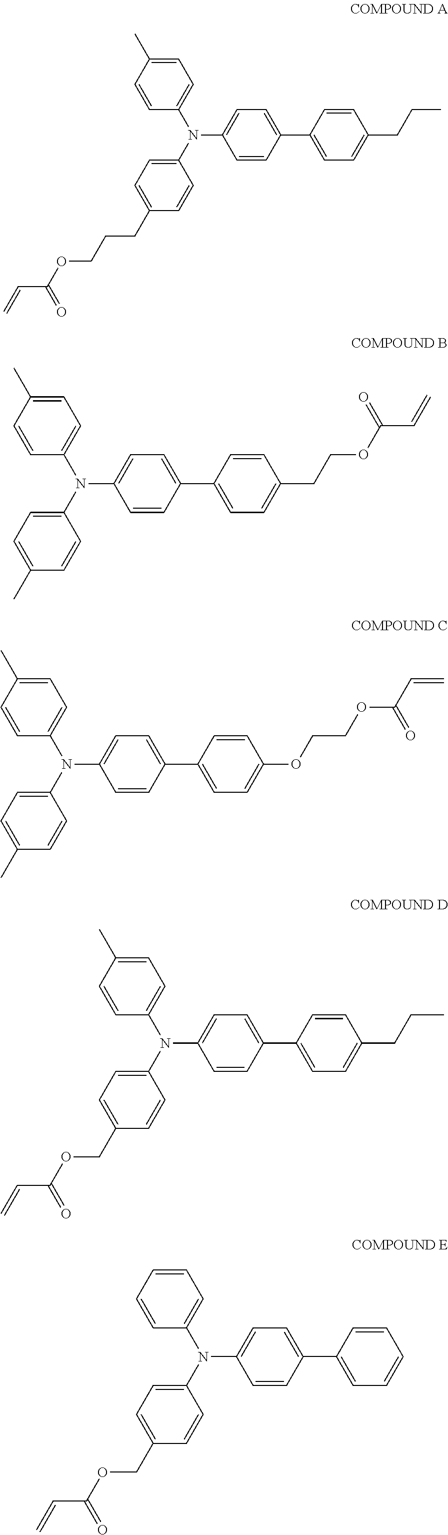

TABLE I
Polymerizable monomer having charge transporting structure

| | Ionization potential |
|---|---|
| | IP₁ |
| Type | [eV] |
| A | 5.68 |
| B | 5.62 |
| C | 5.62 |
| D | 5.65 |
| E | 5.75 |

The chemical structural formulae of the polymerizable monomer (monomer 2) having no charge transporting structure in Table III are shown below. The ionization potentials (IP 2) thereof are shown in Table II.

For example, when “M1” is indicated in the column of the monomer 2 in Table III, the monomer 2 represents trimethylolpropane trimethacrylate.

The chemical structural formulae of the charge transporting material in Table III are shown below. The ionization potentials (IP2) thereof are shown in Table II.

For example, when “F” is indicated in the column of the charge transporting material in Table III, the charge transporting material represents the chemical structural formula of the compound F below.

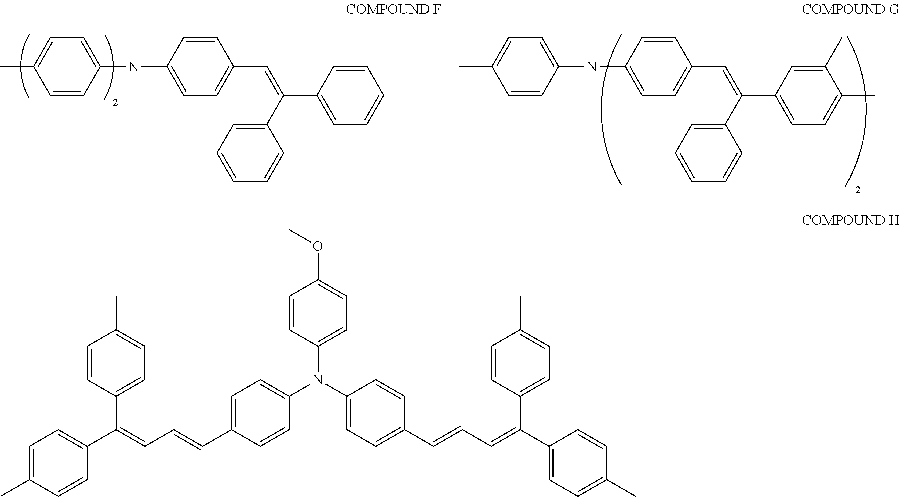

TABLE II
Charge transporting material

| | Ionization potential |
|---|---|
| | IP₂ |
| Type | [eV] |
| F | 5.62 |
| G | 5.40 |
| H | 5.20 |

(A.2.1) Calculation of Mass Ratio of Charge Transporting Material Contained in Protective Layer of Respective Photoreceptor other than Photoreceptor 1

The calculation method of the mass ratio (M_{CT} [%]) of the charge transporting material contained in the protective layer of the respective photoreceptor other than the photoreceptor 1 was performed in the same mariner as in the photoreceptor 1.

Incidentally, m/z value (FF) caused by the chemical structure derived from the charge transporting material contained in the protective layer in the respective photoreceptor other than the photoreceptor 1 (see Table III) and m/z value (F_{A}) caused by the chemical structure derived from the polymerizable monomer (monomer 1 in Table III) having a charge transporting structure contained in the protective layer were determined as appropriate.

### (A.3) Preparation of Photoreceptors 21 and 22

The photoreceptor 21 was prepared in the same manner as in the photoreceptor 1, except that the total layer thickness of the charge transporting layer and the protective layer was 12 μm by setting the layer thickness of the charge transporting layer to 9 μm.

The photoreceptor 22 was prepared in the same manner as in the photoreceptor 1, except that the total layer thickness of the charge transporting layer and the protective layer was 26 μm by setting the layer thickness of the charge transporting layer to 23 μm.

### (Other)

The total layer thickness of the charge transporting layer and the protective layer was measured in the same manner as in the photoreceptor 1.

The measurement of the mass ratio of the charge transporting material is as described above.

### (A.4) Preparation of Photoreceptor 7

### (A.4.1) Preparation of Conductive Support, Formation of Intermediate Layer, Charge Generating Layer, and Charge Transporting Layer

Preparation of the conductive support and formation of the intermediate layer were the same as in the photoreceptor 1.

A charge generating layer and a charge transporting layer of the photoreceptor 7 were formed in the same manner as in the photoreceptor 1, except the type of the charge generating agent, the drying condition of the charge transporting layer, and various conditions regarding the components contained in the coating liquid for forming a protective layer were changed as shown in Table III.

### (A.4.2) Formation of Protective Layer

### (Preparation of Inorganic Fine Particles Contained in Coating Liquid for Forming Protective Layer)

In forming the protective layer, the following inorganic fine particles were prepared in advance.

| | |
|---|---|
| Silica particles | 100 parts by mass |

The above silica particles are “AEROSIL RM50” (manufactured by Nippon Aerosil Co., Ltd.) and have a number average primary particle size of 40 nm.

Hereinafter, the above surface-unmodified silica particles are referred to as “silica particles [1]”. 20 parts by mass of the above silica particles [1] were ultrasonically dispersed in 60 parts by mass of tetrahydrofuran to prepare a dispersion liquid [1].

(Preparation of Coating liquid for Forming Protective Layer)

The following components [5] were mixed and stirred, sufficiently dissolved and dispersed to prepare a coating liquid for forming a protective layer.

### <Components [5]>

| | | |
|---|---|---|
| 2-butanol (solvent 1) | 140 | parts by mass |
| Tetrahydrofuran (solvent 2) | 60 | parts by mass |
| Polymerizable monomer having a | 50 | parts by mass |
| charge transporting structure (compound A) | | |
| Polymerizable monomer having no | 50 | parts by mass |
| charge transporting structure | | |
| Photopolymerization initiator | 5 | parts by mass |

As the polymerizable monomer having no charge transporting structure in the components [5], “SR350” (manufactured by Sartomer), which is a polymerizable monomer having three or more functional groups, was used.

This is trimethylolpropane trimethacrylate, represented by the chemical structural formula M1.

Further, as the photopolymerization initiator in the components [5], “Omnirad819” (manufactured by IGM Resins B.V.) was used.

The dispersion liquid [1] was mixed with the above coating liquid for forming a protective layer to prepare a coating liquid for forming a protective layer.

The prepared coating liquid for forming a protective layer was applied onto the charge transporting layer using a circular slide hopper coating apparatus so that the thickness after drying was 3.5 μm.

Next, photoreceptor 7 was prepared by irradiating UV light using a metal halide lamp for 1 minute and then drying at 110° C. for 70 minutes to form a protective layer.

### (A.4.3) Other

The total layer thickness of the charge transporting layer and the protective layer was measured in the same manner as in the photoreceptor 1.

The measurement of the mass ratio of the charge transporting material is as described above.

### (A.5) Preparation of Photoreceptor 8

### (A.5.1) Preparation of Conductive Support, Formation of Intermediate Layer, Charge Generating Layer, and Charge Transporting Layer

Preparation of the conductive support and formation of the intermediate layer were the same as in the photoreceptor 1.

A charge generating layer and a charge transporting layer of the photoreceptor 8 were formed in the same manner as in the photoreceptor 1, except the type of the charge generating agent, the drying condition of the charge transporting layer, and various conditions regarding the components contained in the coating liquid for forming a protective layer were changed as shown in Table III.

### (A.5.2) Formation of Protective Layer

### (Preparation of Inorganic Fine Particles Contained in Coating Liquid for Forming Protective Layer)

In forming the protective layer, the inorganic fine particles were surface-modified in advance as described below.

The mixture of the components [6] below was placed in a sand mill with zirconia beads and stirred at about 40° C. and at a rotating speed of 1500 rpm.

<Components [6]>

| | | |
|---|---|---|
| Silica particles | 100 | parts by mass |
| Surface modifying agent | 30 | parts by mass |
| S-15 (methacrylic compound) | | |
| Mixed solvent | 300 | parts by mass |

The surface modifying agent S-15 in the components [6] is the following compound.

S-15 CH₂═C(CH₃)COO(CH₂)₃Si(OCH₃)₃

The silica particles in the components [6] are “AEROSIL RM50” (manufactured by Nippon Aerosil Co., Ltd.) and have a number average primary particle size of 40 nm.

The mixed solvent in the components [6] is the mixed solvent of toluene/isopropyl alcohol=1/1 (mass ratio).

The above mixture was charged into a Henschel mixer, stirred at a rotating speed of 1500 rpm for 15 minutes, and then dried at 120° C. for 3 hours to prepare methacrylated silica particles [2].

It was confirmed that the surface of the above silica particles [2] was coated with a surface modifying agent S-15 by detecting the peak of Si using a fluorescent X-ray analyzer “XRF-1700” (manufactured by Shimadzu Corporation).

20 parts by mass of the above methacrylated silica particles [2] were ultrasonically dispersed in 60 parts by mass of tetrahydrofuran to prepare a dispersion liquid [2].

### (Preparation of Coating Liquid for Forming Protective Layer)

The following components [7] were mixed and stirred, sufficiently dissolved and dispersed to prepare a coating liquid for forming a protective layer.

### <Components [7]>

| | | |
|---|---|---|
| 2-butanol (solvent 1) | 140 | parts by mass |
| Tetrahydrofuran (solvent 2) | 60 | parts by mass |
| Polymerizable monomer having a | 50 | parts by mass |
| charge transporting structure (compound A) | | |
| Polymerizable monomer having no | 50 | parts by mass |
| charge transporting structure | | |
| Photopolymerization initiator | 5 | parts by mass |

As the polymerizable monomer having no charge transporting structure in the components [7], “SR350” (manufactured by Sartomer), which is a polymerizable monomer having three or more functional groups, was used.

This is trimethylolpropane trimethacrylate, represented by the chemical structural formula M1.

Further, as the photopolymerization initiator in the components [7], “Omnirad819” (manufactured by IGM Resins B.V.) was used.

The dispersion liquid [2] was mixed with the above coating liquid for forming a protective layer to prepare a coating liquid for forming a protective layer.

The prepared coating liquid for forming a protective layer was applied onto the charge transporting layer using a circular slide hopper coating apparatus so that the thickness after drying was 3.5 μm.

Next, photoreceptor 8 was prepared by irradiating UV light using a metal halide lamp for 1 minute and then drying at 110° C. for 70 minutes to form a protective layer.

### (A.5.3) Other

The total layer thickness of the charge transporting layer and the protective layer was measured in the same manner as in the photoreceptor 1.

The measurement of the mass ratio of the charge transporting material is as described above.

### (A.6) Preparation of Photoreceptor 9

### (A.6.1) Preparation of Conductive Support, Formation of Intermediate Layer, Charge Generating Layer, and Charge Transporting Layer

Preparation of the conductive support and formation of the intermediate layer were the same as in the photoreceptor 1.

The charge generating layer and the charge transporting layer were formed in the same manner as in the photoreceptor 1, except that the type of the charge generating material (pigment type) in the coating liquid for forming the charge generating layer, the type of the charge transporting material in the coating liquid for forming the charge transporting layer, the dry condition thereof, and the layer thickness of the charge transporting layer were changed as shown in the Table III.

### (A.6.2) Formation of Protective Layer

### (Preparation of Inorganic Fine Particles Contained in Coating Liquid for Forming Protective Layer)

In forming the protective layer, the following inorganic fine particles were prepared in advance.

| | |
|---|---|
| α-alumina particles | 100 parts by mass |

The above α-alumina particles have a number average primary particle size of 300 nm.

20 parts by mass of the above a-alumina particles were ultrasonically dispersed in 60 parts by mass of tetrahydrofuran to prepare a dispersion liquid [3].

### (Preparation of Coating Liquid Forming Protective Layer)

The following components [8] were mixed and stirred, sufficiently dissolved and dispersed to prepare a coating liquid for forming a protective layer.

### <Components [8]>

| | | |
|---|---|---|
| 2-butanol (solvent 1) | 140 | parts by mass |
| Tetrahydrofuran (solvent 2) | 60 | parts by mass |
| Polymerizable monomer having a | 50 | parts by mass |
| charge transporting structure (compound A) | | |
| Polymerizable monomer having no | 50 | parts by mass |
| charge transporting structure | | |
| Photopolymerization initiator | 5 | parts by mass |

As the polymerizable monomer having no charge transporting structure in the components [8], “SR350” (manufactured by Sartomer), which is a polymerizable monomer having three or more functional groups, was used.

This is trimethylolpropane trimethacrylate, represented by the chemical structural formula M1.

Further, as the photopolymerization initiator in the components [8], “Omnirad819” (manufactured by IGM Resins B.V.) was used.

The dispersion liquid [3] was mixed with the above coating liquid for forming a protective layer to prepare a coating liquid for forming a protective layer.

The prepared coating liquid for forming a protective layer was applied onto the charge transporting layer using a circular slide hopper coating apparatus so that the thickness after drying was 3.5 μm.

Next, photoreceptor 9 was prepared by irradiating UV light using a metal halide lamp for 1 minute and then drying at 110° C. for 70 minutes to form a protective layer.

### (A.6.3) Other

The total layer thickness of the charge transporting layer and the protective layer was measured in the same manner as in the photoreceptor 1.

The measurement of the mass ratio of the charge transporting material is as described above.

### B. Preparation of Toner Particles

Toner particles 1 to 3 were prepared by the following procedure.

### (B.1) Preparation of Toner Particles 1

The preparation procedure of the toner particles 1 is as follows.

### (Preparation of Dispersion Liquid of Resin Fine Particles for Core Section)

A surfactant solution in which 4 parts by mass of polyoxyethylene-2-dodecyl ether sodium sulfate was dissolved in 3040 parts by mass of ion-exchanged water was charged into a reaction vessel equipped with a stirring device, a temperature sensor, a cooling tube, and a nitrogen introduction device, and the internal temperature was raised to 80° C. while stirring the solution at a stirring rate 230 rpm under a nitrogen gas flow.

A polymerization initiator solution in which 10 parts by mass of a polymerization initiator (potassium persulfate: KPS) was dissolved in 3040 parts by mass of ion-exchanged water to this surfactant solution, and the temperature was set to 75° C., and then a monomer mixed solution consisting of 532 parts by mass of styrene, 200 parts by mass of n-butyl acrylate, 68 parts by mass of methacrylic acid, and 16.4 parts by mass of n-octyl mercaptan was added dropwise to the solution over 1 hour.

The system was subjected to polymerization (first stage polymerization) by heating and stirring at 75° C. for 2 hours to prepare a dispersion of resin fine particles [A].

The weight-average molecular weight (Mw) of the resin fine particles [A] prepared by the first-stage polymerization was 16500.

Measurement of the weight average molecular weight (Mw) was conducted by using Gel permeation

chromatography “HLC-8220” (manufactured by Tosoh Corporation) and columns “TSKguardcolumn+TSKgelSuperHZM-M3 series” (manufactured by Tosoh Corporation). While holding the column temperature at 40° C., tetrahydrofuran (THF) as a carrier solvent is flowed at a flow rate of 0.2 ml/min, the measurement sample is dissolved in tetrahydrofuran so as to have a concentration of 1 mg/ml under a condition in which dissolution treatment is performed for 5 minutes using an ultrasonic disperser at room temperature, then treated with a membrane filter having a pore size of 0.2 μm to obtain a sample solution. 10 μl of this sample solution is injected into the device together with the carrier solvent described above, and detected using a refractive index detector (RI detector). The molecular weight distribution of the measurement sample is calculated using a calibration curve measured using monodisperse polystyrene standard particles.

Standard polystyrene samples having respective molecular weights of 6×10², 2.1×10³, 4×10³, 1.75×10⁴, 5.1×10⁴, 1.1×10⁵, 3.9×10⁶, 8.6×10⁵, 2×10⁶, 4.48×10⁶ manufactured by Pressure Chemical Corporation were used as standard polystyrene samples for calibration curve measurement, and standard polystyrene samples having at least about 10 points were measured to prepare a calibration curve. A refractive index detector was used as the detector.

In a flask equipped with a stirrer, 101.1 parts by mass of styrene, 62.2 parts by mass of n-butyl acrylate, 12.3 parts by mass of methacrylic acid, and 1.75 parts by mass of n-octyl mercaptan were mixed with 93.8 parts by mass of paraffin wax “HNP-57” (manufactured by Nippon Seiro Co., Ltd.) as a release agent, and the mixture was heated to 90° C. to dissolve the mixture.

On the other hand, a surfactant solution obtained by dissolving 3 parts by mass of polyoxyethylene-2-dodecyl ether sodium sulfate in 1560 parts by mass of ion-exchanged water was heated to 98° C., and 32.8 parts by mass (in terms of solid content) of a dispersion liquid of the aforementioned resin fine particles [A] was added to this surfactant solution, and a monomer solution containing the paraffin wax was mixed and dispersed for 8 hours by a mechanical disperser “Kreamix” (manufactured by M Technique Co., Ltd.) having a circulation path, thereby preparing a dispersion liquid containing emulsified particles having a dispersion particle size of 340 nm.

Next, a polymerization initiator solution in which 6 parts by mass of potassium persulfate was dissolved in 200 parts by mass of ion-exchanged water was added to the emulsified particle dispersion, and the system was heated and stirred at 98° C. for 12 hours to carry out polymerization (second stage polymerization), thereby preparing a dispersion of resin fine particles [B].

The weight average molecular weight (Mw) of the resin fine particles [B] prepared by the second stage polymerization was 23000.

A polymerization initiator solution in which 5.45 parts by mass of potassium persulfate was dissolved in 220 parts by mass of ion-exchanged water was added to the resin fine particles [B], and a monomer mixed solution of 293.8 parts by mass of styrene, 154.1 parts by mass of n-butyl acrylate, and 7.08 parts by mass of n-octyl mercaptan was added dropwise over 1 hour under the condition of 80° C.

After completion of the dropwise addition, polymerization (third stage polymerization) was performed by heating and stirring for 2 hours, and then cooled to 28° C. to obtain a dispersion of fine resin particles for the core portion.

The weight average molecular weight (Mw) of the resin fine particles for the core-portion was 26800. In addition, the volume-based average particle size of the resin fine particles for the core portion was 125 nm.

Further, the glass transition temperature (Tg) of the resin fine particles for the core-portion was 30.5° C.

### (Preparation of Dispersion Liquid of Resin Fine Particles for Shell Layer)

In the first stage polymerization in the preparation of the dispersion of the resin fine particles for the core portion, the polymerization reaction and the post-reaction treatment were carried out in the same manner except that the monomer mixed solution having 548 parts by mass of styrene, 156 parts by mass of 2-ethylhexyl acrylate, 96 parts by mass of methacrylic acid, and 16.5 parts by mass of n-octyl mercaptan was used.

The glass transition temperature (Tg) of the resin fine particles for the shell layer was 49.8° C.

### (Preparation of Colorant Particulate Dispersion)

90 parts by mass of dodecyl sodium sulfate was added to 1600 parts by mass of ion-exchanged water, and while the solution was stirred, 420 parts by mass of carbon black “Legal 330R” (manufactured by Cabot Co., Ltd.) was gradually added, followed by dispersion treatment using a stirring device “Kreamix” (manufactured by M Technique Co., Ltd.), thereby preparing a colorant fine particle dispersion liquid in which colorant fine particles were dispersed.

The particle size of the colorant fine particles in the colorant fine particle dispersion liquid was measured using an electrophoretic light-scattering photometer “ELS-800” (manufactured by Otsuka Electronics Co., Ltd.), and was found to be 110 nm.

### (Formation of Core Portion)

420 parts by mass (in terms of solid content) of the dispersion liquid of the resin fine particles for the core portion, 900 parts by mass of the ion-exchanged water, and 100 parts by mass of the colorant fine particle dispersion liquid were placed and stirred in a reactor to which a thermal sensor, a cooling tube, a nitrogen-introducing device, and a stirrer were attached.

After adjusting the temperature in the reactor to 30° C., pH of the solution was adjusted to 8-11 by adding 5 mol/L of sodium hydroxide aqueous solution to the solution.

Then, an aqueous solution obtained by dissolving 60 parts by mass of magnesium chloride hexahydrate in 60 parts by mass of ion-exchanged water was added under stirring at 30° C. for 10 minutes.

After standing for 3 minutes, the temperature rise was started, and the system was raised to 80° C. (core portion forming temperature) over 80 minutes.

Under that condition, the particle size of the particles was measured in the flow-type particle image analyzer “FPIA2100” (manufactured by Sysmex Co., Ltd.). When the volume-based average particle size of the particles became 5.8 μm, an aqueous solution in which 40.2 parts by mass of sodium chloride was dissolved in 1000 parts by mass of ion-exchanged water was added to the solution to stop the particle size growth. Further, as a ripening treatment the solution was heated and stirred for 1 hour at 80° C. of liquid temperature (core section ripening temperature) to continue a fusion to form a core portion.

The circularity of the core portion was measured by the flow-type particle image analyzer “FPIA2100” (manufactured by Sysmex Co., Ltd.), and found to be 0.930.

Further, the core portion was observed at 10000× magnification by scanning transmission electron microscopy using a field emission scanning electron microscope “JSM-7401F” (manufactured by JEOL Ltd.), and it was confirmed that the colorant was dissolved in the fused resin and no colorant dispersed fine particles remained.

### (Formation of Shell Layer)

Next, 46.8 parts by mass (in terms of solid content) of the dispersion liquid of the resin fine particles for the shell layer was added at 65° C. Further, an aqueous solution obtained by dissolving 2 parts by mass of magnesium chloride hexahydrate in 60 parts by mass of ion-exchanged water was added over a period of 10 minutes.

Thereafter, the temperature was raised to 80° C. (shelling temperature), stirring was continued for 1 hour, and the resin fine particles for the shell layer were fused to the surface of the core portion.

Thereafter, the shell layer was formed by performing a ripening treatment at 80° C. (shell ripening temperature) to a predetermined circularity.

Here, an aqueous solution obtained by dissolving 40.2 parts by mass of sodium chloride in 1000 parts by mass of ion-exchanged water was added, and the mixture was cooled to 30° C. under a condition of 8° C./min.

The fused particles formed were filtered and washed repeatedly with ion-exchanged water at 45° C.

Thereafter, the mixture was dried with hot air at 40° C.

Based on the above procedure, toner base particles having a shell layer on the surface of the core portion and having a negative polarity were obtained.

The toner base particles had a volume-based average particle size of 5.9 μm, a glass-transition-temperature (Tg) of 31° C., and an average circularity of 0.960.

### (Addition of External Additive)

An external additive was added to the prepared toner base particles by the following procedure.

0.12 parts by mass of zinc stearate particles (“MZ-2” volume-based average particle size: 2.0 μm; manufactured by Nippon Oil Co., Ltd.) which are fatty acid metal salt (metal soap) particles as a lubricant were added to 100 parts by mass of the dried toner base particles, and was mixed for 3 minutes at 30° C. with 15 m/seconds of the stirring blade peripheral speed, using a Henschel mixer “FM10B” (manufactured by Mitsui Miike Kakoki Co., Ltd.).

Thereafter, the coarse particles were removed using a sieve having an opening of 90 μm to prepare toner particles 1.

### (B.2) Preparation of Toner Particles 2 and 3

In the preparation of toner particles 1, toner particles 2 and 3 were prepared by changing the lubricant as shown in table IV.

### C. Image Forming and Assessment

### <Charge Rise Characteristics>

Electrophotographic photoreceptors prepared in Examples and Comparative Examples were 100 krot (0.1 million rotations) in a durability test, and then left overnight in a low-temperature and low-humidity (temperature: 10° C., humidity: 20% RH).

A modified machine was made by modifying the developing machine with “bizhub C658” (Konica Minolta, Inc.).

After a developer was removed from the developing machine, a surface electrometer was installed at the developing position.

Each electrophotographic photoreceptor after being left overnight was mounted on the above-described modified machine, and the direct current (DC) voltage of the applied voltage of the charging roller was set to 500V, and a Vpp value of AC voltage was set to Vknee+75V corresponding to each photoreceptor, and white solid images were obtained, and surface potentials (AV G) of the fourth and fifth rotations of the photoreceptor were measured.

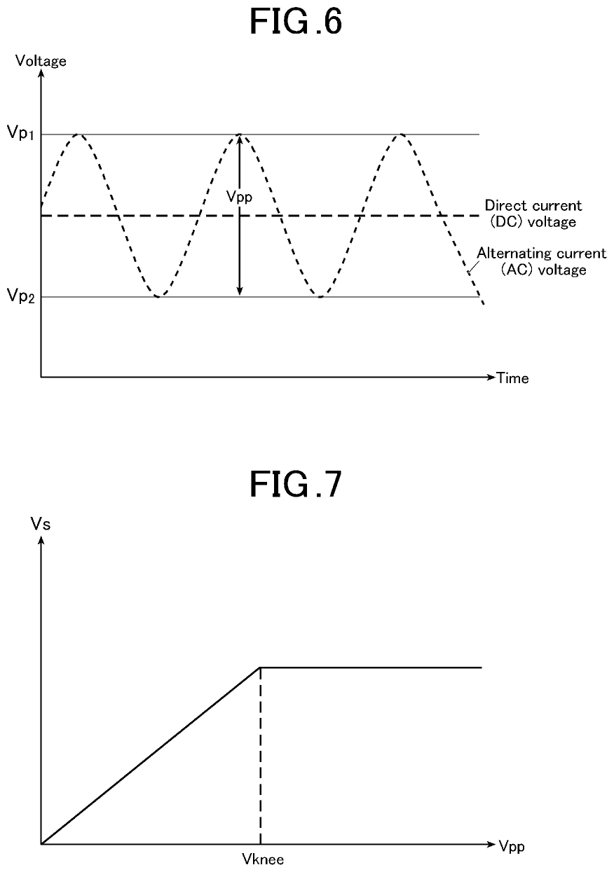

In the above-described measurement, the “Vpp value” is an absolute value (|Vp₁−Vp₂|) of the difference between the smallest value (Vp₁) and the largest value (Vp₂) of the alternating current (AC) voltage waveform (see FIG. 6).

At this time, the direct current (DC) voltage is expressed by (Vp₁−Vp₂)/2.

Further, “Vknee” will be described (see FIG. 7).

In case that the graph is created with Vpp value taken on the horizontal axis and a surface potential (Vs) of the photoreceptor taken on the vertical axis, when Vpp is increased the surface potential (Vs) of the photoreceptor rises in proportion to Vpp, and is saturated at a certain potential to indicate the inflection point.

Vpp value when the inflection point is indicated is Vknee.

In other words, the smallest Vpp at which the surface-potential (Vs) of the photoreceptor is saturated is Vknee.

Charge rise characteristics were evaluated from the measured surface potential (ΔV₀) of the photoreceptor, and the results are shown in table III.

The evaluation criteria are shown below.

It should be noted that those ΔV₀ is less than 9V (evaluation is A, B, and C) is passed, and those ΔV₀ is 9V or more (evaluation is D) is rejected.

### (Evaluation Criteria)

A: ΔV₀ is greater than or equal to 0V and less than 4V.
B: ΔV₀ is greater than or equal to 4V and less than 7V.
C: ΔV₀ is greater than or equal to 7V and less than 9V.
D: ΔV₀ is greater than or equal to 9V.

### <Characteristics of Cracks>

Electrophotographic photoreceptors prepared in Examples and Comparative Examples were coated with sebum, Zernet cream, and industrial oil over a fixed area, and left 24 h in a thermostatic bath at 40° C. and humidity 85% RH, and visually evaluated whether or not cracks occurred in those photoreceptors, and the results are shown in table III.

The evaluation criteria are shown below.

Incidentally, although it goes without saying that there are only two evaluations, those cracks are not generated (evaluation is A) is passed, those cracks are generated (evaluation is D) is rejected.

### (Evaluation Criteria)

A: No cracks occurred.
D: Cracks occurred.

TABLE III

| | | | | | Examples or Comparative Examples | | | | | | | | | |
|---|---|---|---|---|---|---|---|---|---|---|---|---|---|---|
| | | | | | Ex- | Ex- | Ex- | Ex- | Ex- | Ex- | Ex- | Ex- | Ex- | Ex- |
| | | | | | ample | ample | ample | ample | ample | ample | ample | ample | ample | ample |
| | | | | | 1 | 2 | 3 | 4 | 5 | 6 | 7 | 8 | 9 | 10 |
| | | | | | Photoreceptor No. | | | | | | | | | |
| | | | | | 1 | 2 | 3 | 4 | 5 | 6 | 7 | 8 | 9 | 10 |
| Charge | Charge | | Type | | TiOPc | TiOPc | TiOPc | TiOPc | TiOPc | TiOPc | TiOPc | TiOPc | TiOPc | TiOPc |
| generating | generating | | | | | (Diol | | | | | | | | |
| layer | agent | | | | | type) | | | | | | | | |
| Charge | Drying | | Tem- | | 120 | 120 | 120 | 120 | 120 | 120 | 120 | 120 | 120 | 120 |
| transport | Condition | | perature | | | | | | | | | | | |
| layer | | | (° C.) | | | | | | | | | | | |
| | | | Time | | 60 | 60 | [symbol] 0 | 60 | 60 | [symbol] 0 | 60 | 60 | [symbol] 0 | 60 |
| | | | [min] | | | | | | | | | | | |
| Protection | Components | Solvent | 1 | ( [symbol] ) | 140 | 140 | 140 | 140 | 140 | 140 | 140 | 140 | 140 | 140 |
| layer | contained | | | Content | | | | | | | | | | |
| | in coating | | | [% by | | | | | | | | | | |
| | liquid for | | | mass] | | | | | | | | | | |
| | forming | | 2 | ( [symbol] ) | 60 | 60 | 60 | 60 | 60 | 60 | 60 | 60 | 60 | 60 |
| | protective | | | Content | | | | | | | | | | |
| | layer | | | [% by | | | | | | | | | | |
| | | | | mass] | | | | | | | | | | |
| | | Mono- | 1 | Type | A | A | B | C | D | A | A | A | A | A |
| | | mer | 2 | Type | M1 | M1 | M1 | M1 | M1 | M1 | M1 | M1 | M1 | M1 |

| | | | | | | | | | | |
|---|---|---|---|---|---|---|---|---|---|---|
| [symbol] P difference | 0.06 | 0.06 | 0.06 | 0.06 | 0.06 | 0.06 | 0.06 | 0.06 | 0.06 | 0.06 |
| [eV] | | | | | | | | | | |
| [symbol] | | | | | | | | | | |

| | Metal oxide | Type | — | — | — | — | — | — | Silica | Silica | α- | — |
|---|---|---|---|---|---|---|---|---|---|---|---|---|
| | particles | | | | | | | | | | alumina | |
| | | Surface | — | — | — | — | — | — | None | Methacryl | None | — |
| | | modification | | | | | | | | | | |
| | Charge | Type | F | F | F | F | F | F | F | F | F | F |
| | transporting | M [symbol] [%] | 3.1 | 3.1 | 3.2 | 3.3 | 3.2 | 3.1 | 3.1 | 3.1 | 3.1 | 3.1 |
| | material | | | | | | | | | | | |
| Total layer thickness [μm] (*2) | | | 21 | 21 | 21 | 21 | 21 | 21 | 21 | 21 | 21 | 21 |
| Charge r [symbol] | | ΔV [symbol] [V] | 5 | 5 | 6 | 4 | 5 | 6 | 4 | 4 | 5 | 2 |
| | | Evaluation | B | B | B | B | B | B | B | B | B | A |

| | | | | | | | | | | | |
|---|---|---|---|---|---|---|---|---|---|---|---|
| [symbol] characteristics | Evaluation | A | A | A | A | A | A | A | A | A | A |
| Density level difference | Evaluation | B | B | B | B | B | B | B | B | B | A |

*1: IP difference = Polymerizable monomer having charge transporting structure ( [symbol] ) [symbol] Ionization potential (IP [symbol] ) of charge transporting material
*2: Total layer thickness of charge transport layer and protective layer [symbol]
indicates data missing or illegible when filed

### <Density Level Difference>

After the charge rise was each evaluated, electrophotographic photoreceptor prepared in Examples and Comparative Examples was left overnight in a low-temperature and low-humidity (temperature: 10° C., humidity: 20% RH), and then the electrophotographic photoreceptor was mounted on a “bizhub C658” (manufactured by Konica Minolta, Inc.), halftone images (average relative reflection density : 0.4 measured by a Macbeth densitometer) were copied on the entire surface of A3 neutral paper, and the density of halftone images formed using a fluorescence spectrophotometer FD-7 (manufactured by Konica Minolta, Inc.) was measured.

At this time, developers using the toner particles as described in table IV were supplied to a developing device.

Photoreceptors that are of cylindrical shape having a diameter of 30 mm and a circumference of 94.2 mm were used.

In forming the images, photoreceptor numbers (No.), the type of lubricants contained in the developer supplied by the developing device, and the type of chargers were combined as shown in table IV.

The measurement point of the density of the halftone image was a total of eight points: four points from the corner of A3 paper (horizontal 297 mmx vertical 420 mm) to the position of 50 mm in the vertical direction, such that 60 mm interval is made from one end of the horizontal (the measurement point of the density of photoreceptor 1st turn: the measurement point Pr₁), and four points from the corner of A3 paper to the position of 144 mm in the horizontal direction, such that 60 mm interval is made from one end of the horizontal (the measurement point of the density of photoreceptor 2nd turn: the measurement point Pr₂).

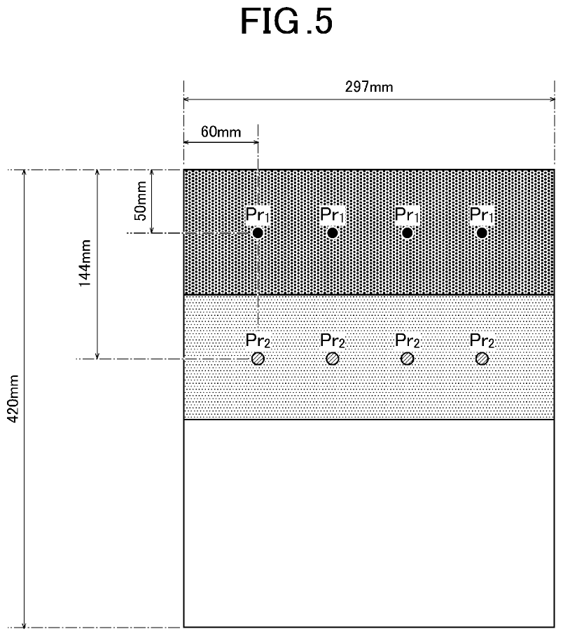

FIG. 5 is a schematic diagram illustrating an example of a measurement point at the time of measuring a density level difference.

For the density measurement, the reflection density at each point was measured with a Macbeth densitometer.

The density (Cr₁) at the first rotation of photoreceptor was defined as average value of densities measured at 4 measurement points Pr₁.

In addition, the density (Cr₂) at the second rotation of photoreceptor was defined as average value of densities measured at 4 measurement point Pr₂.

The density level difference was evaluated using the density (Cr₁) of the first rotation of photoreceptor and the density (Cr₂) of the second rotation of photoreceptor for the halftone images determined as described above according to the following criteria.

The evaluation criteria are shown below.

It should be noted that those the value of Cr₁-Cr₂ is less than 0.04 (evaluation is A, B, and C) is passed, and those the value of Cr₁-Cr₂ is 0.04 or more (evaluation is D) is rejected.

### (Evaluation Criteria)

A: Cr₁-Cr₂ is less than 0.01 (good).
B: Cr₁-Cr₂ is greater than or equal to 0.01 and less than 0.02 (no practical problem).
C: Cr₁-Cr₂ is 0.02 or more and less than 0.04 (practically feasible).
D: Cr₁-Cr₂ is 0.04 or more (there is a practical problem).

TABLE IV

| | | | | | Density |
|---|---|---|---|---|---|
| Example or | | Developer | | | level |
| Comparative | Photoreceptor | Toner particles | | | difference |
| Examples | No. | No. | Lubricant | Charger | Evaluation |
| Example 1 | 1 | 1 | Zinc stearate | Proximity charging roller and Contact charging roller | B |
| Example 2 | 2 | 1 | Zinc stearate | Proximity charging roller and Contact charging roller | B |
| Example 3 | 3 | 1 | Zinc stearate | Proximity charging roller and Contact charging roller | B |
| Example 4 | 4 | 1 | Zinc stearate | Proximity charging roller and Contact charging roller | B |
| Example 5 | 5 | 1 | Zinc stearate | Proximity charging roller and Contact charging roller | B |
| Example 6 | 6 | 1 | Zinc stearate | Proximity charging roller and Contact charging roller | B |
| Example 7 | 7 | 1 | Zinc stearate | Proximity charging roller and Contact charging roller | B |
| Example 8 | 8 | 1 | Zinc stearate | Proximity charging roller and Contact charging roller | B |
| Example 9 | 9 | 1 | Zinc stearate | Proximity charging roller and Contact charging roller | B |
| Example 10 | 10 | 1 | Zinc stearate | Proximity charging roller and Contact charging roller | A |
| Example 11 | 11 | 1 | Zinc stearate | Proximity charging roller and Contact charging roller | A |
| Example 12 | 12 | 1 | Zinc stearate | Proximity charging roller and Contact charging roller | A |
| Example 13 | 13 | 1 | Zinc stearate | Proximity charging roller and Contact charging roller | B |
| Example 14 | 14 | 1 | Zinc stearate | Proximity charging roller and Contact charging roller | B |
| Example 15 | 21 | 1 | Zinc stearate | Proximity charging roller and Contact charging roller | B |
| Example 16 | 22 | 2 | Zinc stearate | Proximity charging roller and Contact charging roller | B |
| Example 17 | 1 | 1 | — | Proximity charging roller and Contact charging roller | B |
| Example 18 | 1 | 3 | Zinc stearate | Scorotron charging | C |
| Example 19 | 1 | 1 | Silica | Proximity charging roller and Contact charging roller | C |
| Comparative Example 1 | 15 | 1 | Zinc stearate | Proximity charging roller and Contact charging roller | D |
| Comparative Example 2 | 16 | 1 | Zinc stearate | Proximity charging roller and Contact charging roller | D |
| Comparative Example 3 | 17 | 1 | Zinc stearate | Proximity charging roller and Contact charging roller | D |
| Comparative Example 4 | 18 | 1 | Zinc stearate | Proximity charging roller and Contact charging roller | D |
| Comparative Example 5 | 19 | 1 | Zinc stearate | Proximity charging roller and Contact charging roller | D |
| Comparative Example 6 | 20 | 1 | Zinc stearate | Proximity charging roller and Contact charging roller | D |

From table III, it can be seen that electrophotographic photoreceptors of the present invention have better charge rising property and no cracks, compared with electrophotographic photoreceptors of the comparative example.

In addition, as shown in table IV, the image formed by the electrophotographic image forming apparatus of the present invention had a good quality with a smaller density level difference, compared with the image formed by the electrophotographic image forming apparatus of the comparative example.

From the above, it can be seen that both abrasion resistance and high image quality can be achieved in long-term use.

Although the expression mechanism or action mechanism of the effect of the present invention has not been clarified, but it is presumed as follows.

The electrophotographic photoreceptor of the present embodiment is characterized in that the charge generating layer contains titanyl phthalocyanine or a derivative thereof, the charge transporting layer contains a charge transporting material, and a ratio of a mass of the charge transporting material in the protective layer is greater than 3% by mass and less than 9% by mass with respect to the total mass of the reactants of the specified monomers and the charge transporting material.

Note that the charge transporting material in the protective layer may have diffused and migrated from the charge transporting layer to the protective layer, or may be intentionally added to adjust the charge transporting material to a desired ratio.

As described above, conventionally, by forming a crosslinked film having a charge transporting structure on the charge transport layer, the amount of diffusion and transfer of the charge transporting material from the charge transport layer to the protective layer is controlled.

Thus, reduction of photoreceptor wear and increase of residual potential are suppressed, and image defects such as generation of image memories are prevented.

Incidentally, in recent image formation, it has become important to obtain a desired toner charge amount by friction in a very short time, and the charge rising property of how quickly and uniformly charged is emphasized.

However, there are problems in that the quality of the formed image deteriorates due to, for example, the occurrence of cracks in a photoreceptor and the occurrence of image noises by the density level difference, caused by deterioration of the charge rising property in the low-temperature and low-humidity environment after the durability test.

First, the reason why the charge rising property is deteriorated will be described in consideration of an electrophotographic photoreceptor in which a charge generating layer, a charge transporting layer, and a protective layer are provided in this order on a support, and a crosslinked film having a charge transporting structure is formed on the protective layer.

In a low-temperature and low-humidity environment, the temperature of the photoreceptor decreases, so that the positive hole transporting ability at the interface between the charge transporting layer and the protective layer decreases.

Positive holes generated in the charge generating layer pass through the charge transporting layer and eventually migrate to the charge transporting structure of the protective layer.

At this time, if the positive hole transporting ability at the interface between the charge transporting layer and the protective layer is deteriorated, the positive holes cannot be transferred to the charge transporting structure in the protective layer successfully, and the positive holes are accumulated at the interface between the charge transporting layer and the protective layer, i.e. transferring of the positive hole is troubled.

As described above, the decrease in the positive hole transporting ability at the interface between the charge transporting layer and the protective layer is a cause of the decrease in the charge rising property.

Next, the influence on the image quality due to the deterioration of the charge rising property will be described.

When the charge rising property decreases, a level difference of the post exposure half-potential (Vₘ) occurs.

The post-exposure half potential (V m) refers to a potential that is approximately ½ of the power supply voltage, and is a half potential corresponding to a level difference of the charging potential (Vo) at the charge rise.

As a result, image noises due to the density level difference corresponding to the rotational cycle of the photoreceptor are generated at the time of forming the half image. This is the influence on image quality.

The “half image” is a dot image used for a printing test or the like, and is, for example, an image in which 50% of all printing units (all dots) are printed.

In view of the above, it is possible to prevent image noise caused by the density level difference by suppressing a decrease in the positive hole transporting ability or suppressing a decrease in the charge rising property by improving the positive hole transporting ability.

However, if the positive hole transporting ability at the interface between the charge transporting layer and the protective layer is too high, the amount of the charge transporting material that diffuses and migrates from the charge transporting layer to the protective layer becomes excessive, and the polymerization of the polymerizable monomers forming the protective layer is inhibited.

When the polymerization of the polymerizable monomers is inhibited, the crosslinked structure of the protective layer is not sufficiently formed, and cracks are caused by adhesion and erosion of sebum, oil, and the like.

As a result, photoreceptor wear rate is increased, the performance of the photoreceptor cannot be maintained for a long period of time, and a high quality image cannot be provided at the time of image forming.

Therefore, in order to extend the lifetime of the photoreceptor and to provide high quality images, it is also required to keep the amount of the charge transporting material transferred from the charge transporting layer to a certain amount or less.

From the above, by setting a ration of a mass of the charge transporting material contained in the protective layer within a certain specific range, it is possible to suppress a decrease in the charge rising property and to control the amount of the charge transporting material that is transferred from the charge transporting layer to the protective layer to an appropriate range.

As a result, cracks in the photoreceptor are suppressed, the life of the photoreceptor is extended, and the density level difference is small even in image forming, so that an image can be obtained within an allowable quality.

In the present embodiment, the charge generating material contained in the charge generating layer is titanyl phthalocyanine or a derivative thereof.

Although embodiments of the present invention have been described and illustrated in detail, the disclosed embodiments are made for purposes of illustration and example only and not limitation. The scope of the present invention should be interpreted by terms of the appended claims

1. An electrophotographic photoreceptor comprising a photosensitive layer on a support, wherein
the photosensitive layer includes at least a charge generating layer, a charge transporting layer, and a protective layer,
the charge generating layer contains titanyl phthalocyanine or a derivative thereof,
the charge transporting layer contains a charge transporting material,
the protective layer contains a reactant of a polymerizable monomer having a charge transporting structure and a polymerizable monomer having no charge transporting structure, and the charge transporting material, and
a ratio of the mass of the charge transporting material contained in the protective layer is greater than 3% by mass and less than 9% by mass with respect to the total mass of a reactant of the polymerizable monomer having the charge transporting structure and the polymerizable monomer having no charge transporting structure, and the charge transporting material.

2. The electrophotographic photoreceptor according to claim 1, wherein a total thickness of the charge transporting layer and the protective layer is in the range of 13 to 25 μm.

3. The electrophotographic photoreceptor according to claim 1, wherein the absolute value of difference in ionization potential between the polymerizable monomer having the charge transporting structure and the charge transporting material is less than or equal to 0.35 eV.

4. The electrophotographic photoreceptor according to claim 1, wherein the protective layer contains metal oxide particles.

5. The electrophotographic photoreceptor according to claim 4, wherein the metal oxide particles are SiO₂ particles.

6. The electrophotographic photoreceptor according to claim 4, wherein the metal oxide particles are surface-modified with a surface modifying agent having a radically polymerizable group.

7. The electrophotographic photoreceptor according to claim 4, wherein the metal oxide particles are surface-modified with a surface modifying agent having an acryl group or a methacryl group.

8. The electrophotographic photoreceptor according to claim 1, wherein a ratio of the mass of the charge transporting material contained in the protective layer is greater than 3% by mass and less than 5% by mass with respect to the total mass of a reactant of the polymerizable monomer having the charge transporting structure and the polymerizable monomer having no charge transporting structure, and the charge transporting material.

9. The electrophotographic photoreceptor according to claim 1, wherein the photosensitive layer contains a solvent having a solubility parameter of 10[(cal/cm³)^{1/2}] or more and a molecular structure of 4 or more carbon atoms.

10. A method for manufacturing an electrophotographic photoreceptor comprising: manufacturing the electrophotographic photoreceptor according to claim 1, the method comprising:
at least a step of forming the charge transporting layer and the protective layer using a coating liquid,
wherein the coating liquid for forming the protective layer contains a solvent having a solubility parameter of 10[(cal/cm³)^{1/2}] or more and a molecular structure of 4 or more carbon atoms.

11. An electrophotographic image forming apparatus comprising a charger, an exposure device, a developing device and a transfer device, further comprising
the electrophotographic photoreceptor according to claim 1.

12. The electrophotographic image forming apparatus according to claim 11, wherein the charger is a proximity charging roller and a contact charging roller.

13. The electrophotographic image forming apparatus according to claim 12, wherein a developer supplied by the developing device contains a lubricant.

14. The electrophotographic image forming apparatus according to claim 13, wherein the lubricant is a metal soap.
